(19) United States
(12) Patent Application Publication
(10) Pub. No.: US 2007/0071291 A1
(43) Pub. Date: Mar. 29, 2007

(54) Information generating apparatus utilizing image comparison to generate information

(75) Inventors: Manabu Yumoto, Nara-shi (JP); Manabu Onozaki, Nara-shi (JP); Masayuki Ehiro, Osaka (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/528,670

(22) Filed: Sep. 28, 2006

(30) Foreign Application Priority Data
Sep. 29, 2005 (JP) 2005-284980 (P)

(51) Int. Cl. G06K 9/00

(52) U.S. Cl. 382/124

(57) ABSTRACT

An image comparison apparatus is assumed to receive fingerprint data in accordance with one of a sweep sensing method and an area sensing method. In operation when the image comparison apparatus receives an image the apparatus calculates a value of an accumulation of movement vectors obtained between such input images and in accordance with the calculated cumulative value determines a fingerprint inputting and comparing method (or a sensing method), and in accordance with one of the methods calculates similarity between an input fingerprint image and a read reference image and as based on a result of the calculation compares the fingerprint image with the reference image. In accordance with a result of determining a method and a result of comparing the images a symbol for information is generated.

This nonprovisional application is based on Japanese Patent Application No. 2005-284980 with the Japan Patent Office on Sep. 29, 2005, the entire contents of which are hereby incorporated by reference.

### BACKGROUND OF THE INVENTION

1. Field of the Invention

The present invention relates generally to information generating apparatuses utilizing image comparison to generate information and particularly to information generating apparatuses based on a result of such image comparison to generate information.

2. Description of the Background Art

Conventionally when mobile phones, personal digital assistant (PDA) and other similar mobile equipment are operated to input electronic mail and other similar text documents in a method of inputting Japanese text for example by following the Japanese 50-sound chart to input a kana character having a sound of “ko”, a key corresponding to the “K” row must be pressed five times. In particular, creating a document having a lengthy sentence entails pressing keys more frequently and also requires more complicated key operations, resulting in consuming more time to input the text.

To resolve this problem, Japanese Patent Laying-Open No. 2004-287871 discloses that in operating a terminal to input Japanese when a key is contacted to select a consonant the terminal is inclined to select a vowel. This method requires an inclination sensor, an acceleration sensor and/or a similar sensor to detect how the terminal is inclined. Furthermore, it requires that in inputting text, the terminal, held in a hand, be frequently inclined, which is cumbersome and also fatigues the wrist.

As one approach overcoming such problems is studied mounting an image reading sensor in a mobile phone for example to read an image of a fingerprint and utilize the read fingerprint image for application to inputting text.

Conventionally proposed methods of comparing fingerprint images can be classified broadly into image feature matching method and image-to-image matching method. Regarding the former, namely image feature matching, images are not directly compared with each other. Instead, features in the images are extracted and thereafter the extracted image features are compared with each other, as described in KOREDE WAKATTA BIOMETRICS (This Is Biometrics), edited by Japan Automatic Identification Systems Association, Ohmsha, Ltd., pp. 42-44. When this method is applied to fingerprint image comparison, minutiae as shown in FIGS. 18A and 18B (ridge characteristics of a fingerprint that occur at ridge ending (FIG. 18A) and bifurcations (FIG. 18B), and generally, few to several minutiae can be found in a fingerprint image) serve as the image feature. According to this method, minutiae are extracted by image processing from images as shown in FIG. 19; based on the positions, types and ridge information of the extracted minutiae, a similarity score is calculated as the number of minutiae of which relative position and direction match among the images; and the similarity score is incremented/decremented in accordance with match/mismatch in, for example, the number of ridges traversing the minutiae; and thereafter the similarity score thus obtained is compared with a predetermined threshold, and as based on a result of the comparison, the images are compared for identification.

Regarding the latter method, namely in image-to-image matching, from images α and β to be compared with each other as shown in FIGS. 20A and 20B, partial images α1 (FIG. 20C) and β1 (FIG. 20D) that may correspond to the entire area or partial area of the original images are extracted; matching score between partial images α1 and β1 is calculated based on the total sum of difference values, correlation coefficient, phase correlation method or group delay vector method, as the similarity score between images α and β; and the calculated similarity score is compared with a predetermined threshold, and as based on a result of the comparison, images α and β are compared for identification.

Generally speaking, the image-to-image matching method is more robust to noise and finger condition variations (dryness, sweat, abrasion and the like), while the image feature matching method enables higher speed of processing as the amount of data to be compared is smaller, and if an image has inclination, searching for a relative position and direction between features enables matching.

To overcome a disadvantage remaining in the image-to-image matching and image feature matching methods, Japanese Patent Laying-Open No. 2003-323618 discloses a vector (V1, V2, . . . , Vn) are employed to search for a maximum matching score position indicating a position of an image of a partial area (M1, M2, M3, . . . , Mn) in one of two images at which a plurality of partial areas (R1, R2, R3, . . . , Rn) set in the other image have images each (see FIGS. 21A and 21B) attaining a maximum matching score, and in a two dimensional coordinate space defined by coordinates (x, y) indicating a position a plurality of maximum matching score positions indicated by the result of the search are compared with a preset threshold (see FIG. 21C) and a result obtained from the comparison is used to calculate the two image's similarity.

A conventional method of inputting a fingerprint image is basically categorized mainly in an area sensing method (FIGS. 22A and 22B) and a sweep sensing method (FIG. 23) depending on how a finger is placed on an area 199 that a fingerprint sensor has for reading an image. Herein a portion of a tip of an index finger that is opposite its nail is shown placed on area 199.

One sweep sensing method (hereinafter also referred to as a sweep method or mode) is disclosed for example in Japanese Patent Laying-Open No. 05-174133. Furthermore, one area sensing method (hereinafter also referred to as an area method or mode) is disclosed in Japanese Patent Laying-Open No. 2003-323618, as aforementioned. The area sensing method allows information (or an image) of a fingerprint sensed on the entire surface of area 119 to be input at a time. The sweep sensing method indicates a method of sensing a fingerprint of a finger moved on the surface of area 199. In FIG. 22A shows a finger placed on the area 199 surface and moved upward and downward as indicated by an arrow and FIG. 22B shows a finger moved rightward and leftward as indicated by an arrow. In FIG. 22A when the finger is moved downward an image of an upper portion of its fingerprint is read and when the finger is moved upward an image of a lower portion thereof is read. Furthermore in FIG. 22B when the finger is moved leftward an image of a leftward portion of its fingerprint is read and when the finger is moved rightward an image of a rightward portion thereof is read. Thus different image data of a fingerprint are read depending on how a finger is moved.

Mobile phones and other similar miniature equipment have a limited function available to be utilized to input characters. Accordingly there as been a demand for utilizing a function existing in the equipment to input characters, symbols and the like, One such existing function available is a fingerprint reading function provided for the purpose of security.

### SUMMARY OF THE INVENTION

An object of the present invention is to provide an information generating apparatus capable of employing a result of comparing an image read from an object to help to generate and input characters, symbols and other similar variety of information.

To achieve the above object the present invention in one aspect provides an information generating apparatus including: an image input unit including a sensor and inputting image data of an object via the sensor; a reference image storage unit storing reference image data to be compared with image data input by the image input unit; a fixed-image comparison unit comparing the image data input by the image input unit in such a manner that the sensor and the object read by the sensor to provide an image have a fixed relative, positional relationship therebetween with the reference image data read from the reference image storage unit; a varying-image comparison unit comparing the image data input by the image input unit in such a manner that the relative, positional relationship varies with the reference image data read from the reference image storage unit; a determination unit making a decision from the image data input as to which one of the fixed-image comparison unit and the varying-image comparison unit should be employed for comparison; a select unit selecting one of the fixed-image comparison unit and the varying-image comparison unit in accordance with decision data indicating a result of the decision made by the determination unit; and an information generating unit generating information as based on the decision data and comparison result data indicating a result of comparing an image by an image comparison unit as selected by the select unit.

The above described information generating apparatus can generate information as based on a result of determining whether image data input of an object should be compared by the fixed-image comparison unit or the varying-image comparison unit in accordance with whether the sensor and the object have a fixed or varied, relative, positional relationship therebetween, and a result of comparing with reference image data the image data input by an image comparison unit (either the fixed-image comparison unit or the varying-image comparison unit) selected by the select unit in accordance with the result of determining whether the image data input should be compared by the fixed-image comparison unit or the varying-image comparison unit.

Thus information can be readily generated simply by utilizing: whether the object and the sensor have a fixed or varied, relative, positional relationship therebetween when image data is input; and a result of comparing images.

Preferably the information generating unit converts the decision data and the comparison result data to corresponding information. This allows conversion to generate information.

Preferably the information generating apparatus further includes a table having a plurality of items of information stored therein in association with the decision data and the comparison result data. As based on the decision data and the comparison result data, the information generating unit searches the table to read an item of the plurality of items of information that is associated with the decision data and the comparison result data. This allows information to be generated by searching the table and reading information.

Preferably the image input unit inputs image data of the object via the sensor in any one of such a manner that the sensor and the object have the relative, positional relationship therebetween fixed and such a manner that the sensor and the object have the relative, positional relationship therebetween varied. This allows a single sensor to be shared in any of the manners of inputting an image. This can eliminate the necessity of providing a sensor for each manner and thus reduce the apparatus in size and cost.

Preferably the determination unit determines which one of the fixed-image comparison unit and the varying-image comparison unit should be employed to compare the image data input, as based on how the relative, positional relationship between the sensor and the object varies as time elapses when the image input unit inputs image data of the object.

Preferably the image input unit inputs more than one item of the image data as the time elapses and the determination unit detects, as based on the plurality of image data input by the image input unit, how the relative, positional relationship between the sensor and the object varies as the time elapses when the image input unit inputs image data of the object.

Thus whether input image data should be compared by the fixed-image comparison unit or the varying-image comparison unit can be determined from how the relative, positional relationship between the sensor and the object varies as time elapses while the object's image data is input.

Preferably the select unit follows the result of the decision made by the determination unit to activate one of the fixed-image comparison unit and the varying-image comparison unit in accordance with the decision data. As such, it is not necessary to activate both, and a burden involved in a comparison process can be reduced.

Preferably the determination unit starts decision-making when a predetermined period of time elapses after the image input unit starts to input the image data.

The determination unit that can start decision-making when a predetermined period of time elapses after the image input unit starts to input the image data, can make a decision when the image data is steadily input. This can avoid poor precision for comparison.

Preferably the determination unit determines that the varying-image comparison unit is employed for comparison if the image data input indicates the relative, positional relationship varying in an amount larger than a predetermined amount when a predetermined period of time elapses after the image input unit starts to input the image data, otherwise the determination unit determines that the fixed-image comparison unit is employed for comparison.

Thus when the object is moved to sweep the sensor to input image data, i.e., when the relative, positional relationship varies in an amount reaching a predetermined value, the varying-image comparison unit can be used to compare an image. Furthermore, when the object is not moved to sweep the sensor to input an image, i.e., when there is not an image input and the relative, positional relationship does not vary in an amount reaching the predetermined value, then the fixed-image comparison unit can be used to compare an image.

Preferably the determination unit determines whether the image input unit has completed inputting image data. More specifically, if the determination unit determines that the image input unit still inputs image data and the relative, positional relationship varies in an amount larger than a predetermined amount, the determination unit determines that image data input by the image input unit is compared by the varying-image comparison unit. If the determination unit determines that the image input unit has completed inputting image data and the relative, positional relationship varies in an amount equal to or smaller than the predetermined amount, then the determination unit determines that the fixed-image comparison unit is employed for comparison.

Thus the determination unit starts a decision when the object is removed from the sensor and inputting image data is completed. This can prevent disturbance attributed to an image input of a different object from entering a comparison process.

Preferably the object is a fingerprint and the comparison result data includes data indicating to which one of right and left hands the fingerprint belongs.

Thus the user can set to which one of his/her right and left hands a fingerprint to be read via the sensor to provide an image belongs to determine the type of information to be generated by the information generating unit.

Preferably the object is a fingerprint and the comparison result data includes data indicating to which one of a thumb, an index finger, a middle finger, a ring finger and a little finger the fingerprint belongs.

Thus the user can set to which one of his/her thumb, index finger, middle finger, ring finger and little finger a fingerprint to be read via the sensor to provide an image belongs to determine the type of information to be generated by the information generating unit.

The fingerprint to be the object is not limited to a fingerprint of a finger of a hand; it may be a fingerprint of a finger of a foot.

Preferably the comparison result data output by the varying-image comparison unit includes data indicating in which direction the object moves relative to the sensor. This direction is indicated by how the relative, position relationship varies.

Thus the user can change a direction in which an object from which an image should be read by the sensor is moved relative to the sensor, e.g., a direction in which a fingerprint is moved relative to the sensor, to change the type of information to be generated by the information generating unit.

Preferably the information generating unit generates information for creating a document. The information generating apparatus can thus readily generate information for creating the document simply by utilizing: whether the object and the sensor have a fixed or varied, relative, positional relationship therebetween when image data is input; and a result of comparing images.

The present invention in another aspect provides a method of generating information, including the steps of: inputting an image, inputting image data of an object via a previously prepared sensor; comparing a fixed image, comparing the image data input in the step of inputting in such a manner that the sensor and the object read by the sensor to provide an image have a fixed, relative, positional relationship therebetween with reference image data read from a previously prepared reference image storage unit; comparing a varying image, comparing the image data input in the step of inputting in such a manner that the relative, positional relationship varies with the reference image data read from the reference image storage unit; making a decision from the image data input as to which one of the step of comparing a fixed image and the step of comparing a varying image should be employed for comparison; selecting one of the step of comparing a fixed image and the step of comparing a varying image in accordance with decision data indicating a result of a decision made in the step of making a decision; and generating information as based on the decision data and comparison result data indicating a result of comparing the images in one of the step of comparing a fixed image and the step of comparing a varying image, as selected in the step of selecting.

The present invention in still another aspect provides an information generating program product for causing a computer to perform the aforementioned method of generating information.

The present invention in still another aspect provides a storage medium readable by a computer or a similar machine and having the aforementioned information generating program stored therein.

The present invention allows information to be generated simply by utilizing: whether the object and the sensor have a fixed or varied, relative, positional relationship therebetween when image data is input; and a result of image comparison using the input image data.

In particular, mobile equipment for example including mobile phones having an insufficient information inputting function that has mounted therein a function that employs image data input via a sensor to generate information, as described above, can be enhanced in convenience in inputting information.

In particular if the object is a fingerprint and the sensor is a fingerprint image reading sensor then an existing fingerprint image reading sensor of mobile equipment can be used and an information generating function can be mounted without involving upsizing the equipment in configuration.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B are block configuration diagrams of an information generating apparatus in each embodiment.

FIG. 2 shows an example in configuration of a computer having the information generating apparatus of each embodiment mounted therein.

FIGS. 3A and 3B schematically show a mobile phone having the information generating apparatus of each embodiment mounted therein.

FIGS. 4A and 4B show tables having reference data registered therein in accordance with each embodiment.

FIG. 5 shows a 50-sound chart in each embodiment.

FIG. 6 is a table that is referenced to convert a symbol in each embodiment.

FIG. 7 is a flowchart generally indicating a process performed in a method of generating information in each embodiment.

FIG. 8 is a flowchart indicating one example of a process performed in FIG. 7 at step T3.

FIG. 9 is a flowchart of a process performed to calculate a relative, positional relationship between snap shot images in an image comparison process in each embodiment.

FIGS. 10A-10D are diagrams for illustrating a procedure of calculating a relative, positional relationship between snap shot images.

FIG. 11 is a flowchart of one example of a procedure of a process performed in FIG. 7 at step T13.

FIGS. 12A and 12B are flowcharts indicating a procedure of a process performed in FIG. 7 at step T16.

FIG. 13 is a flowchart of one example of a procedure of a process performed in FIG. 7 at step T17.

FIG. 14 is a flowchart of a comparison process performed when an area method is determined.

FIG. 15 is a flowchart of a comparison process performed when a sweep method is determined.

FIGS. 16 and 17 are flowcharts indicating another and still another examples of the procedure of the process performed in FIG. 7 at step T13.

FIGS. 18A and 18B schematically show a minutia representing a feature of an image that is used in conventional art.

FIG. 19 illustrates a conventional image feature matching method.

FIGS. 20A-20D show a conventional image-to-image matching method.

FIGS. 21A-21C represent a result of searching for a position having a high matching score for a plurality of partial areas in a pair of fingerprint images obtained from a single fingerprint and how a movement vector of each partial area distributes.

FIGS. 22A and 22B are views for illustrating a sweep sensing method corresponding to a conventional method of inputting a fingerprint image.

FIG. 23 is a view for illustrating an area sensing method corresponding to a conventional method of inputting a fingerprint image.

### DESCRIPTION OF THE PREFERRED EMBODIMENTS

Hereinafter the present invention will be described in embodiments with reference to the drawings.

In accordance with each embodiment an image comparing function employs a fingerprint sensor that is equivalent or analogous to a conventional sweeping sensor and thus shared by both a sweep sensing mode and an area sensing mode. This can contribute to a cost smaller than when a sweeping sensor and an area sensor are both used, as conventional, and also allows both sensing methods to be implemented. While herein data of an image read from a fingerprint sensed is used as image data to be compared for the sake of illustration, the image data is not limited thereto; it may be image data of other biometrics features that are similar among samples (individuals) but not identical, such as vein, iris and the like.

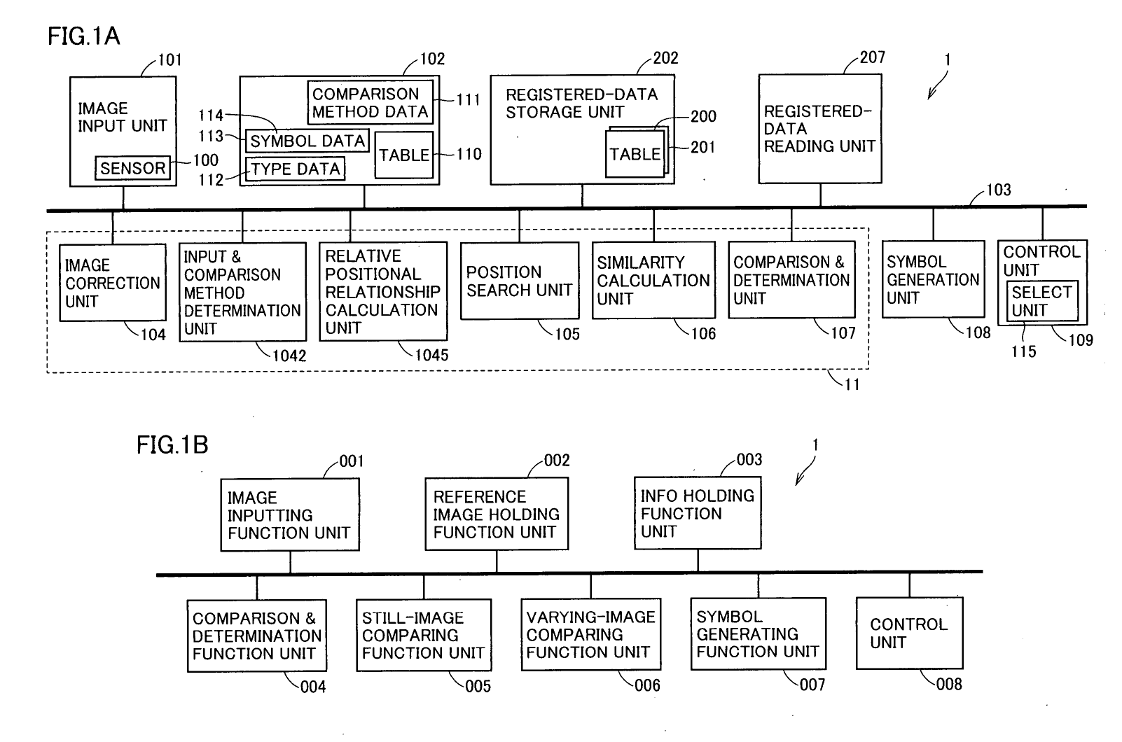

FIGS. 1A and 1B are block configuration diagrams of an information generating apparatus 1 having an image comparing function applied to each embodiment. FIGS. 1A and 1B show components, respectively, which have a correspondence therebetween, as follows: an image inputting function unit 001 corresponds to an image input unit 101; a reference image holding (or storing) function unit 002 corresponds to a registered-data storage unit 202; an information holding (or storing) unit 003 corresponds to a memory 102; a comparison and determination function unit 004 corresponds to fingerprint input and comparison method determining unit 1042 (hereinafter referred to as “input and comparison method determining unit 1042”; a still-image comparing function unit 005 corresponds to a maximum matching position search unit 105 (hereinafter referred to as “position search unit 105”), a similarity score calculation unit 106 based on movement vector, and comparison and determination unit 107; a varying-image comparing function unit 006 corresponds to a calculation unit 1045 calculating a relative, positional relationship between snap shot images, position search unit 105, similarity score calculation unit 106, and comparison and determination unit 107; a symbol generating function unit 007 corresponds to a symbol generation unit 108; a control unit 008 corresponds to a control unit 109. Furthermore the FIG. 1A memory 102 and control unit 109 have a memory area, a controlling function associated with each function unit of FIG. 1B in general.

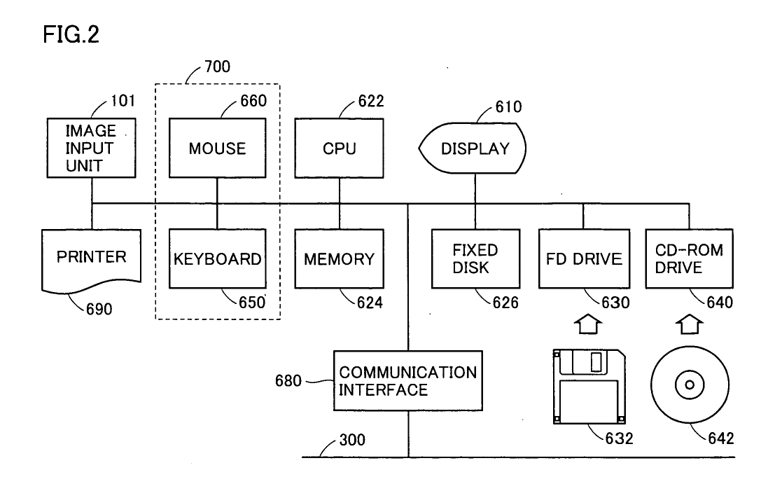

FIG. 2 shows a configuration of a computer having mounted therein information generating apparatus 1 of each embodiment having an image comparing function. Referring to FIG. 2, the computer includes image input unit 101, a display 610 such as a cathode ray tube (CRT) or a liquid crystal display, a central processing unit (CPU) 622 for central management and control of the computer itself, a memory 624 including read only memory (ROM) or random access memory (RAM), a fixed disk 626, an FD drive 630 to which a flexible disk (FD) 632 is detachably mounted and which accesses the mounted FD 632, a Compact Disc Read Only Memory (CD-ROM) drive 640 to which a CD-ROM 642 is detachably mounted and which accesses the mounted CD-ROM 642, a communication interface 680 for connecting the computer to a communication network 300 for communication, a printer 690, and an input unit 700 having a keyboard 650 and a mouse 660. These components are communicatively connected through a bus.

The computer may be provided with a magnetic tape device accessing a cassette-type magnetic tape detachably mounted thereto.

If the computer corresponds to a mobile information terminal 2 as described later, it would exclude printer 690 and mouse 660. Furthermore, it would have FD drive 630 and CD-ROM drive 640 replaced with a memory card access mechanism. Furthermore, if mobile information terminal 2 is a mobile phone, it would have a radio communication unit.

With reference to FIG. 1A, information generating apparatus 1 includes image input unit 101, memory 102 corresponding to memory 624 or fixed disk 626 shown in FIG. 2, a registered-data storage unit 202, a registered-data reading unit 207, a comparison process unit 11, symbol generation unit 108, control unit 109 controlling these units, and a bus 103 connecting the components mutually communicatively. Control unit 109 includes a select unit 115.

Select unit 115 operates in accordance with a result of a decision made by input and comparison method determination unit 1042 to selectively activate still-image comparing function unit 005 or varying-image comparing function unit 006.

Comparison process unit 111 includes an image correction unit 104, input and comparison method determination unit 1042, calculation unit 1045 calculating a relative, positional relationship, position search unit 105, a similarity score calculation unit 106, and a comparison and determination unit 107. Comparison process unit 11 has each unit having its function implemented by executing a corresponding program. However, these functions may be implemented otherwise. For example, these functions may have a portion or its entirety implemented by hardware (a circuit).

Memory 102 stores a table 110, a comparison method data 111 and type data 112, as will be described later, and also has a buffer 113. Buffer 113 is stored with symbol data 114. Furthermore, registered-data storage unit 202 has previously stored therein tables 200 and 201, which will be described later, referenced by comparison and determination unit 107.

Image input unit 101 includes a fingerprint sensor 100 and inputs fingerprint image data that corresponds to a fingerprint read by fingerprint sensor 100. Fingerprint sensor 100 has area 199 serving as an image reading surface, as has been mentioned hereinbefore. Fingerprint sensor 100 may be any of an optical sensor, a pressure sensor, and an electrostatic capacitive sensor.

Image input unit 101 can read both of data of a fingerprint sensed by fingerprint sensor 100 in a sweep mode and that of a fingerprint sensed by fingerprint sensor 100 in an area mode. Whenever in image input unit 101 fingerprint sensor 100 performs a sensing operation once, i.e., whenever a fingerprint corresponding to an object to be sensed is read like a snap shot, image data is input. This image data is referred to as snap shot image data. While an object is placed on area 199, fingerprint sensor 100 regularly reads the object, and whenever fingerprint sensor 100 does so, image input unit 101 inputs image data for the sake of illustration.

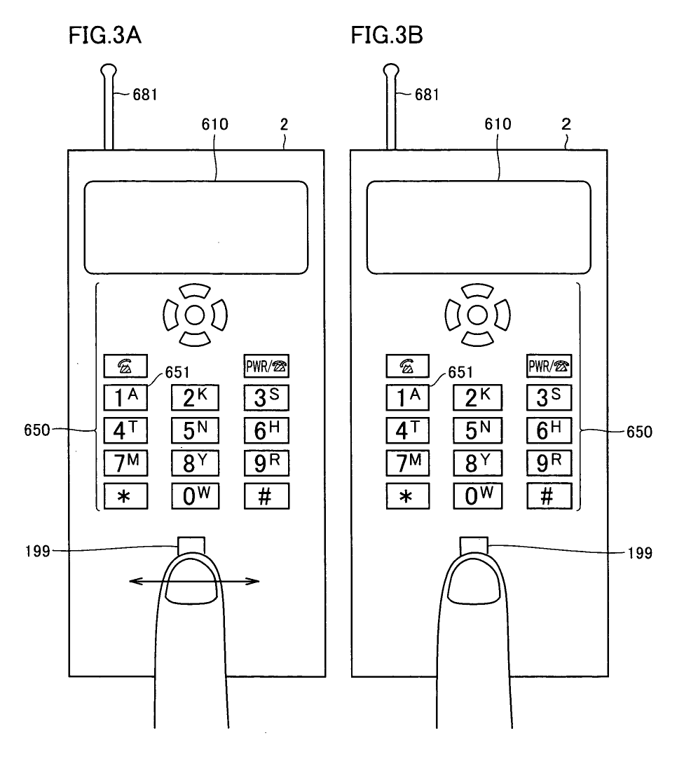

FIGS. 3A and 3B schematically show a mobile phone 2 corresponding to one example of a mobile information terminal having the FIGS. 1A and 1B information generating apparatus 1 mounted therein. Mobile phone 2 includes an antenna 681 for communication interface 680 and on a main surface of a casing thereof has a console including display 610, keyboard 650 and area 199 serving as a fingerprint reading surface of fingerprint sensor 100. Mobile phone 2 thus has a function allowing an input via keyboard 650 and a function allowing an input via fingerprint sensor 100 as a function allowing characters, symbols and other similar information to be input. This allows electronic mail or a similar document to be created via both keyboard 650 operated to input characters a fingerprint sensor 100 operating to input characters.

For sensing in the sweep mode, as shown in FIG. 3A, a finger is placed in a relative position relationship such that its fingerprint surface is parallel to area 199 corresponding to an elongate fingerprint reading surface, and the finger is moved on area 199 from rightward to leftward, or vice versa, as indicated by an arrow (and thus varied in relative, positional relationship), while the fingerprint's data is read.

For sensing in the area mode, in contrast, as shown in FIG. 3B, a finger is placed in a relative, positional relationship such that its fingerprint surface is parallel to area 199 (or the finger is lightly pressed against area 199) and also has the positional relationship unchanged (or fixed) i.e., the finger is not moved (or is still) on area 199, while the fingerprint's data is read.

In the present embodiment area 199 is required to have a size minimally required to allow sensing in the area mode. For example it has a width corresponding to approximately 1.5 time a fingerprint surface to be read (256 pixels) and a length corresponding to approximately 0.25 time a finger (64 pixels). Note that it is assumed that area 199 is previously determined in size by measuring and thus obtaining a size of a fingerprint surface of a typical finger that serves as a candidate for sensing.

The present invention assumes employing fingerprint sensor 100 having area 199 with a length of approximately 0.25 time a fingerprint surface of a finger. Accordingly, sensing in the area method requires a processing time shorter than sensing in the sweep method. Furthermore, sensing in the sweep method entails an increased processing time, however it can provide comparison with high precision.

Memory 102 stores in addition to table 110 image data and various calculation results. Bus 103 is used for transferring control signals and data signals between the units. Image correction unit 104 performs density correction for fingerprint image data input from image input unit 101. Position search unit 105 uses as a template a plurality of partial areas set in one fingerprint image, and searches for a position in the other fingerprint image that attains a highest matching score with the template. In other words, it has a function of a so-called template matching unit. Similarity score calculation unit 106 uses information indicating a result of the search by position search unit 105 and stored in memory 102 to calculate a similarity score based on a movement vector which will be described hereinafter. Comparison and determination unit 107 determines from the similarity score calculated by similarity score calculation unit 106 whether an image matches or fails to match. Symbol generation unit 108 operates as based on a method determined by input and comparison method determination unit 1042 and a result of a comparison done by comparison and determination unit 107 to search table 110 to read information of interest from the table. The read information is stored to buffer 113 as symbol data 114. Symbol data 114 is passed via buffer 133, as controlled by CPU 622, to a document editing function (a document editing program) mounted in the computer of FIG. 2 or mobile phone 2 of FIGS. 3A and 3B and is utilized in inputting a character to create a document or a character string. For mobile phone 2, the document editing function includes a function allowing main text of electronic mail to be edited.

In the image comparison process, from tables 200 and 201 of registered-data storage unit 202, registered-data reading unit 207 reads image data, which is in turn used as reference image data to be compared with input image data. Hereinafter tables 200 and 201 having a reference image registered therein for generating information will be described.

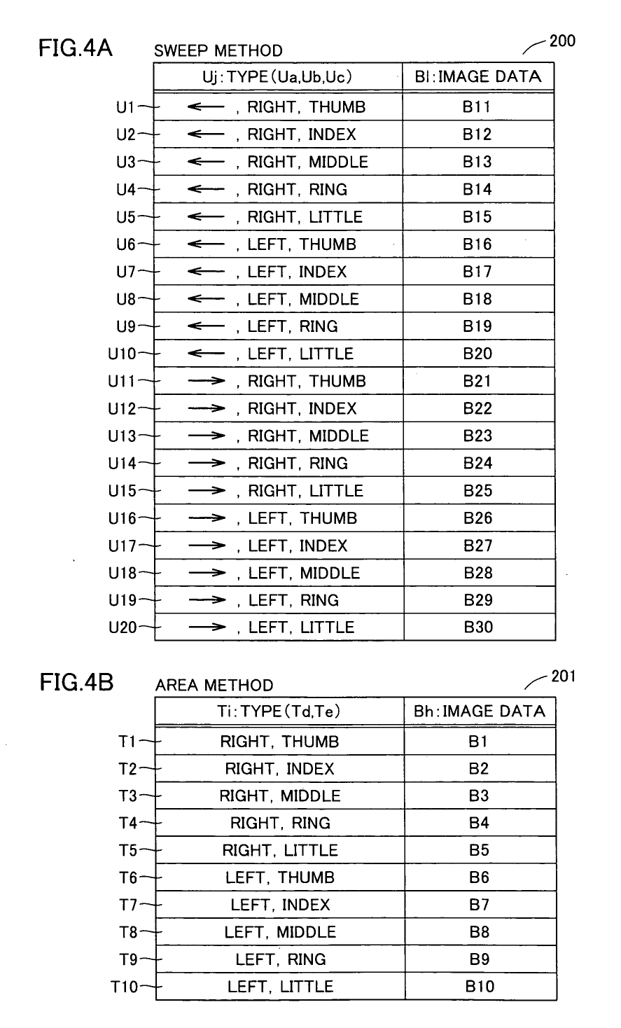

FIGS. 4A and 4B show table 200 having reference image data Bl registered therein for the sweep mode, wherein 111, 12, 13, . . . , 30, and table 201 having reference image data Bh registered therein for the area mode, wherein h=1, 2, 3, 10).

In FIG. 4A, table 200 has previously stored therein image data Bl of a fingerprint of a user read by fingerprint sensor 100 in the sweep mode and type data Uj associated with image data Bl, respectively, wherein j=1, 2, 3, . . . , 20. Image data BI indicates fingerprint image data read when the user places on area 199 that side of a finger tip of each of a thumb, an index finger, a middle finger, a ring finger and a little finger of his/her right or left hand which is opposite to the finger's nail, and moves (or sweeps) the finger from his/her rightward to leftward (in a direction indicated in the figure by ‘←’) or his/her leftward to rightward (in a direction indicated in the figure by ‘→’). Type data Uj indicates for image data Bl corresponding thereto how the fingerprint of the image data is read and the type of the fingerprint (or an object to be read). More specifically, type data Uj includes data Ua, Ub and Uc. Data Ua indicates as a manner a value indicating a direction in which a finger is moved in reading a fingerprint. This value can indicate either ‘→’ (a rightward direction) or ‘←’ (a leftward direction). Data Ub indicates a value indicating whether the fingerprint corresponding thereto is of a right hand or a left hand. This value can indicate either “right” or “left”. Data Uc indicates a value indicating which one of five fingers i.e., a thumb, an index finger, a middle finger, a ring finger and a little finger, the fingerprint corresponding thereto is. This value can indicate a value of any of “thumb”, “index”, “middle”, “ring” and “little”.

In FIG. 4B, table 201 has previously stored therein image data Bh of a fingerprint of a user read by fingerprint sensor 100 in the area mode and type data Ti associated with image data Bh, respectively, wherein i=1, 2, 3, . . . , 10. Image data Bh indicates fingerprint image data read when the user places on area 199 that side of a finger tip of each of a thumb, an index finger, a middle finger, a ring finger and a little finger of his/her right or left hand which is opposite to the finger's nail, and does not move the finger. Type data Ti indicates for image data Bh corresponding thereto a type of a fingerprint corresponding thereto (i.e., a type of an object to be read). More specifically, type data Ti includes data Td and Te. Data Td indicates a value indicating whether the fingerprint corresponding thereto is of a right hand or a left hand. This value can indicate either “right” or “left”. Data Te indicates a value indicating which one of five fingers i.e., a thumb, an index finger, a middle finger, a ring finger and a little finger, the fingerprint corresponding thereto is. This value can indicate a value of any of “thumb”, “index”, “middle”, “ring” and “little”.

Tables 200 and 201 have data registered therein in a procedure as will be described hereinafter. This procedure is applied to the FIG. 2 computer and the FIGS. 3A and 3B mobile phone 2 similarly. Initially a user operates keyboard 650 to set the computer or mobile phone 2 in a reference image data registration mode in the sweep mode or that in the area mode. The computer or mobile phone 2 shifts in mode of operation to the registration mode in the set mode.

In the registration mode in the sweep mode the user places a finger tip of his/her right or left hand on area 199 and causes fingerprint sensor 100 to read a fingerprint in the sweep mode. In this registration mode the user operates keyboard 650 to input data indicative of a reading manner (a direction in which the finger is moved) and an object to be read (whether the hand of interest is a right hand or a left hand and which of thumb, index, middle, ring and little fingers is read). CPU 622 stores data of an image of a fingerprint read by and output from fingerprint sensor 100 as image data Bl and data received via keyboard 650 as type data Uj in association with each other to registered-data storage unit 202 at a memory area previously ensured for table 200.

In accordance with such procedure the fingerprints of all of the fingers of the right and left hands are read in the sweep mode and image data Bl is input and each associated with type data Uj input via keyboard 650 for that image data Bl, and thus stored in a memory area previously ensured for table 200. Table 200 is thus generated.

In the registration mode in the area mode the user places a finger tip of his/her right or left hand on area 199 and causes fingerprint sensor 100 to read a fingerprint in the area mode. In this registration mode the user operates keyboard 650 to input data indicative of an object to be read (or whether the hand of interest is a right hand or a left hand and which of thumb, index, middle, ring and little fingers is read). CPU 622 stores data of an image of a fingerprint output from fingerprint sensor 100 as image data Bh and data received via keyboard 650 as type data Ti in association with each other to registered-data storage unit 202 at a memory area previously ensured for table 201.

In accordance with such procedure the fingerprints of all of the fingers of the right and left hands are read in the area mode and image data Bh is input and each associated with type data Ti input via keyboard 650 for that image data Bh, and thus stored in a memory area previously ensured for table 201. Table 201 is thus generated.

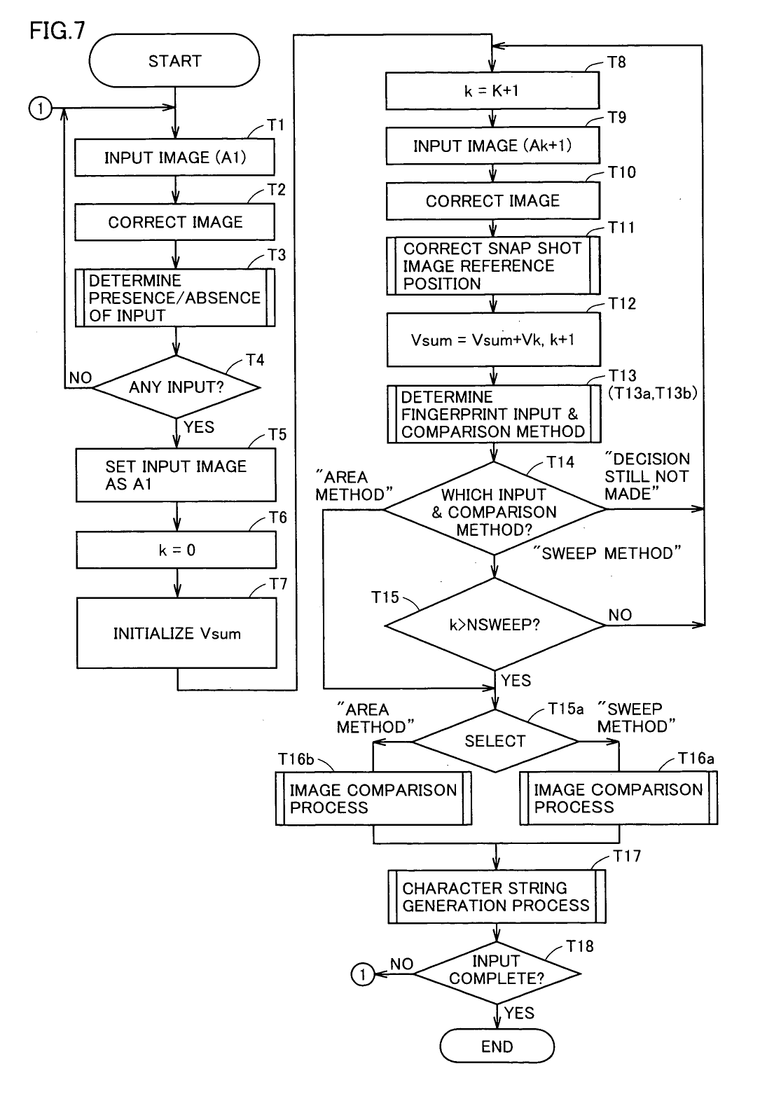

Note that image data Bl and Bh stored in tables 200 and 201 are input in accordance with a procedure shown in FIG. 7 at steps T1-T5 as will be described later.

In the present embodiment, for example for editing electronic mail, ‘kana’ characters are input in accordance with the 50-sound chart. In the present embodiment, ‘kana’ characters are input in a combination of the area method and the sweep method. Table 110 is referenced in inputting ‘kana’ characters in accordance with a Roman alphabetized version of the 50-sound chart.

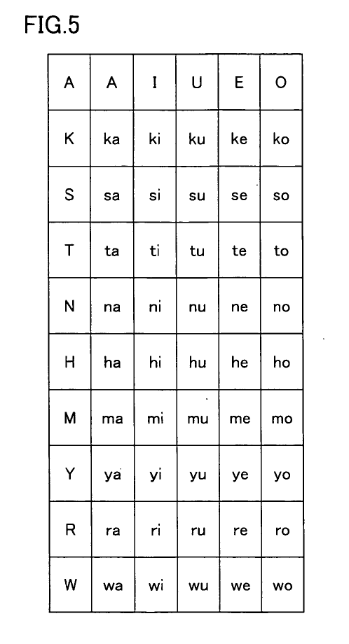

FIG. 5 shows the 50-sound chart in a Roman alphabetized version indicating a list of the ‘kana’ characters phonetically represented. In FIG. 5, the 50-sound chart has 10 rows or “A”, “K”, “S”, . . . , and “W” rows each arranged to extend as a row, and five sounds for each row, forming a column. One ‘kana’ character has a sound represented by a vowel (‘A’, ‘I’, ‘U’, ‘E’, ‘O’) alone or a combination of a consonant (‘K’, ‘S’, ‘T’, ‘N’, ‘H’, ‘M’, ‘Y’, ‘R’, ‘W’) and a vowel. In the 50-sound chart as shown in FIG. 5, of the “A”, “K”, “S”, . . . , and “W” rows, the “A” row has its kanas all phonetically represented by vowels, respectively, alone, while the other rows have their respective kanas each phonetically represented in a combination of a consonant and a vowel.

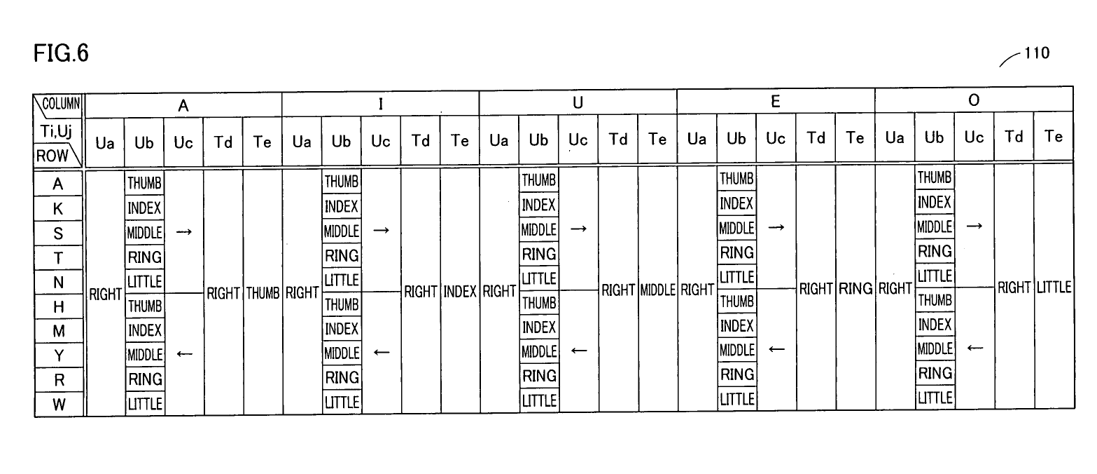

In FIG. 6, table 110 has items “row” and “column” corresponding to the rows and columns of the 50-sound chart as shown in FIG. 5 and an item “Ti, Uj” indicating a combination of type data Ti and Uj registered in tables 200 and 201 such that the three types of items are associated with each other. As an element for the item “Ti, Uj”, a combination in value of data Ua, Ub, Uc, Td and Te of type data Ti and Uj of tables 200 and 210 is previously registered. As an element for the item “row”, or the “A”, “K”, “S”, . . . , and “W” rows, consonants shared to phonetically represent their respectively corresponding rows' ‘kana’ characters, i.e., ‘K’, ‘S’, ‘T’, ‘N’, ‘H’, ‘M’, ‘Y’, ‘R’, ‘W’, are previously registered. Note that the “A” row has its five ‘kana’ characters each phonetically represented by a vowel alone, and herein for the sake of convenience “A” is registered as such element. As an element for the item “column”, vowels (‘A’, ‘I’, ‘u’, ‘E’, ‘O’) are previously registered for phonetically representing each row's ‘kana’ characters. Thus in table 110 the 50-sound chart provides kanas each indicated by a combination of an element (a consonant) of the item “row” and an element (a vowel) of the item “column” and the combination is designated by using a value of a combination of elements of the item “Ti, Uj”.

This allows table 110 to be searched through by a value of data Ta, Tb, Tc, Ua and Ub of type data Ti or Uj read from tables 200 and 201 to specify and read a combination of a vowel and a consonant phonetically representing a ‘kana’ character (for the “A” row, a combination of a vowel and a vowel).

As a specific example, reading “A” (the “A” row's first ‘kana’ character) from table 110 will be considered for the sake of illustration. In that case, a search is conducted with the item “Ti, Uj” having data Ua indicating “right”, data Ub indicating “thumb” and data Uc indicating “→”, and data Td indicating “right” and data Te indicating “thumb”. More specifically, a user in the sweep mode moves his/her right thumb from leftward to rightward to input a fingerprint image and then in the area mode inputs an image of his/her right thumb (a fingerprint located at a center of a tip of the finger). Thus in the present embodiment it is assumed that when a user inputs a ‘kana’ character in accordance with the 50-sound chart via fingerprint sensor 100, the user initially inputs data of an image of a fingerprint in the sweep method and then inputs data of an image of a fingerprint in the area method.

In the present embodiment table 100 has the items “row” and “column” having elements registered in the form of vowels and consonants as a value for the 50-sound chart. However, it is not limited thereto. For example, the 50-sound chart may be regarded as a two-dimensional arrangement formed of a row (Xa) and a column (Yb) and a value of the row (Xa) and that of the column (Yb) may be registered. More specifically in the two-dimensional arrangement the “row” has a range of Xa=1, 2, 3, 4, 5, . . . , 10 and the “column” has a range of Yb=1, 2, 3, 4, 5. The arrangement thus has each element (Xa, Yb) having a value corresponding to one of the kana characters of the 50-sound chart. This allows table 10 to be searched through as based on type data Ti and Uj to read a value of an element (Xa, Yb) of the arrangement that corresponds thereto to uniquely determine in the 50-sound chart a ‘kana’ character corresponding to the value of the element (Xa, Yb) read of the arrangement. The ‘kana’ thus determined can be used to input a character.

Information generating apparatus 1 employs image comparison to generate (or input) information in a method, as will now be described hereinafter with reference to FIG. 7 showing a flowchart. In accordance with the FIG. 7 flowchart a program is read from a predetermined memory by CPU 622 and executed thereby when a predetermined application program is initiated in the FIG. 2 computer or the FIGS. 3A and 3B mobile phone 2. The predetermined application program is assumed to be a electronic mail or similar document editing program. Note that it is assumed that table 110 is stored in memory 102 and tables 200 and 201 are stored previously in registered-data storage unit 202.

As will be described hereinafter, the control initially waits until a finger is placed on fingerprint sensor 100 at a fingerprint reading surface or area 199 (steps T1-T4).

Initially, control unit 109 signals image input unit O1 to start inputting an image, and then waits until it is signaled that an image has been input. When image input unit 101 receives from fingerprint sensor 100 image data A1 subjected to comparison, image input unit 101 stores the data through bus 103 to memory 102 at a predetermined address (step T1). After image input unit 101 competes inputting image data A1, it signals control unit 109 that an image has been input.

Control unit 109 then signals image correction unit 104 to start correcting the image and then waits until it is signaled that the image has been corrected. In most cases, an input image has uneven image quality as each pixel's tone and overall density distribution vary because of characteristics of image input unit 101, the degree in dryness of the skin of the finger itself, the pressure applied by the finger on the sensor, and the like. Therefore, it is not appropriate to use the input image's data directly for comparison. Accordingly image correction unit 104 corrects the input image in quality to suppress variations in conditions under which the image is input (step T2). Specifically, for the entirety of an image corresponding to input image data or each small areas into which the image is divided, histogram planarization, as described in Computer GAZOU SHORI NYUMON (Introduction to computer image processing), SOKEN SHUPPAN, p. 98, or image binarization, as described in Computer GAZOU SHORI NYUMON (Introduction to computer image processing), SOKEN SHUPPAN, pp. 66-69, and/or the like are/is performed on image data A1 stored in memory 102. When image correction unit 104 completes an image correction process for image data A1, it signals control unit 109 accordingly. The above described process is repeated until a decision is made in steps T3 and T4 that there is an input.

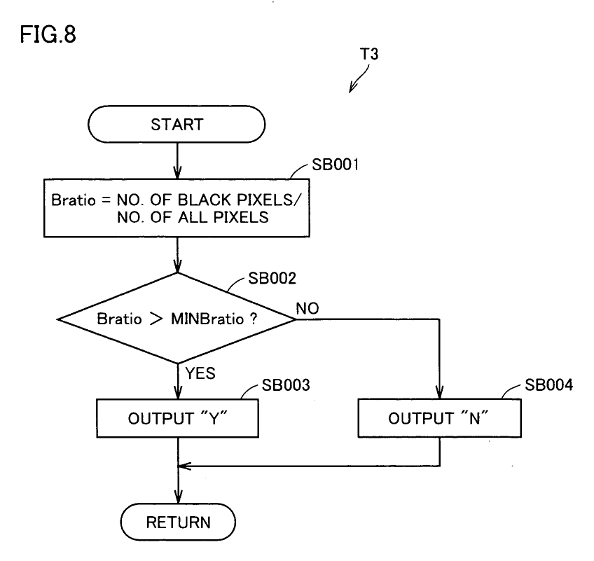

Step T3 will be described more specifically with reference to FIG. 8. Initially control unit 109 divides the total number of black pixels of an image indicated by image data A1 input, which corresponds to a ridge line of a fingerprint image, by the number of pixels of the entirety including white pixels serving as a background to calculate a value Bratio indicating a ratio of black pixels (step SB001). If value Bratio is larger than a value MINBratio then a decision is made that a finger is placed on area 119 serving as the finger reading surface and data ‘Y’ indicating that there is an input is returned to a previous process (the process shown in FIG. 7). Otherwise, data ‘N’ indicating that there is no input is returned to the previous process (steps SB002-SB004).

With reference again to FIG. 7, if in step T3 data 1N′ is returned the control returns to step T1 and repeats a process subsequent thereto. If data Y is returned, then image data A1 input and corrected is stored to memory 102 at a particular address (step T5) and control unit 109 initializes in value a variable k and a cumulative movement vector Vsum stored in memory 102 at a predetermined address for controlling the process indicated in FIG. 7 (steps T6, T7). In the initialization a value of zero is assigned to variable k and (0, 0) is assigned to cumulative movement vector Vsum. Variable k is then incremented by one (step T8).

Subsequently, as done in steps T1 and T2, (k+1)th image data Ak+1 is input and image data Ak+1 is subjected to correction (steps T9, T10).

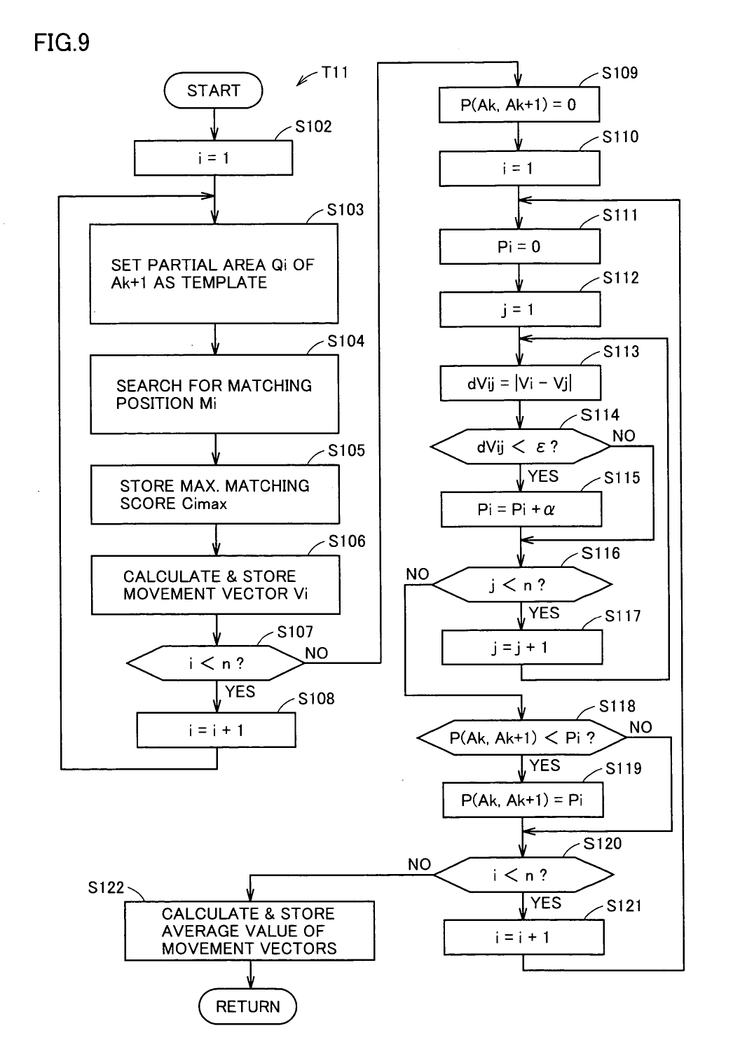

A Movement vector Vk, k+1 representing a relative, positional relationship between image data Ak of a snap shot image immediately previously input and image data Ak+1 of a snap shot image subsequently input, is calculated (step T11). This will be described with reference to FIG. 9 showing a flowchart.

In the FIG. 9 flowchart initially control unit 109 signals calculation unit 1045 calculating a relative, positional relationship to start template matching, and awaits until it is signaled that the template matching ends. Calculation unit 1045 starts such a template matching process as indicated in steps S103 through S108.

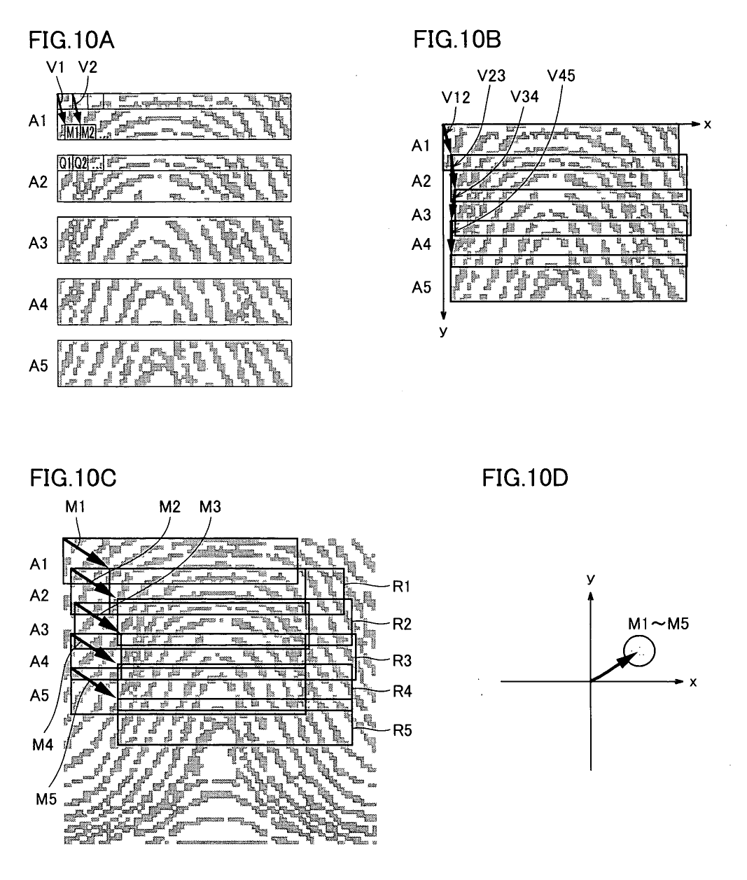

The template matching process as referred to herein is generally described as follows: image data Ak has a plurality of partial area images and so does image data Ak+1, and the template matching process is performed to search for which of the partial area images of image data Ak each of those of image data Ak+1 best matches, i.e., the process is performed to search for a position of a maximum matching score. Specifically, for example, referring to FIG. 10A, the position at which each of a plurality of partial images Q1, Q2, . . . of snap shot image data A2 attains the best match with one of partial images M1, M2, . . . of snap shot image data A1 is searched for. Details will be described in the following:

In step S102, a counter has a variable i initialized to have a value of one. In step S103 calculation unit 1045 sets, as a template used for template matching, an image of a partial area defined as a partial area Qi, which corresponds to an area corresponding to four pixel lines on the image of image data Ak+1 that is divided for every four vertical pixels by every four horizontal pixels, wherein i=1, 2, 3, . . . . Such a partial area's image will also be referred to as a partial image Qi.

Herein, while partial area Qi is a rectangle to simplify calculation, it is not limited thereto. In step S104, calculation unit 1045 causes a search to be conducted for a location of data in the image of image data Ak that has a matching score Ci (s, t) highest with respect to the template set in step S103. More specifically, position search unit 105 assumes that: with the upper left corner of partial area Qi serving as a template serving as a reference, coordinates (x, y) provide a pixel density Qi (x, y), and with the upper left corner of image data Ak serving as a reference, coordinates (s, t) provide a pixel density Ak (s, t); partial area Qi has a width w and a height h; and each pixel of partial image Qi and the image of image data Ak can assume a maximum density V0, and position search unit 105 thus calculates matching score Ci (s, t) at the coordinates (s, t) in the image of image data Ak, for example in accordance with the following equation (1):

$$Ci ( s , t ) = {\sum }_{y = 1}^{h} {\sum }_{x = 1}^{w} ( V 0 - \vert Qi ( x , y ) - Ak ( s + x , t + y ) \vert ) , \qquad ( 1 )$$

as based on a difference in density of each pixel.

In the image of image data Ak, the coordinates (s, t) are successively updated and a matching score C (s, t) at the coordinates (s, t) is calculated. A decision is made that, of such matching scores C (s, t) thus calculated, a position (coordinates (s, t)) that has a largest value is a position having a highest matching score, and the image of a partial area corresponding to the position determined as having the highest matching score is set as a partial area M₁ and a matching score C (s, t) calculated for that position is set as a maximum matching score Cimax.

In step S105, maximum matching score Cimax in the image of image data Ak of partial area Qi calculated in step S104 is stored to memory 102 at a predetermined address.

In step S106, a movement vector Vi is calculated in accordance with the following equation (2) and stored to memory 102 at a predetermined address. Herein, as has been described hereinbefore, the image of image data Ak is scanned as based on partial area Qi corresponding to a position P set in the image of image data Ak+1, and consequently when partial area Mi corresponding to position M having a highest score of matching with partial area Qi is detected, a directional vector from position P to position M is herein referred to as a movement vector Vi.
Vi=(Vix, Viy)=(Mix−Qix, Miy−Qiy) (2)

In equation (2), variables Qix and Qiy indicate x and y coordinates of a reference position of partial area Qi, and correspond, by way of example, to coordinates of the upper left corner of partial area Qi in image data Ak. Furthermore, variables Mix and Miy indicate x and y coordinates indicating a position corresponding to a maximum matching score Cimaxn indicating a result of a search for partial area Mi. For example they indicate coordinates of the upper left corner of partial area Mi at a matching position in the image of image data Ak.

In step S107, calculation unit 1045 determines whether variable i is smaller than the total number n of partial areas. If variable i is smaller than the total number n of partial areas, the process proceeds to step S108, otherwise the process proceeds to step S109. In step S108, variable i is incremented by one. Thereafter, while variable i indicates a value smaller than the total number n of partial areas, steps S103 to S108 are repeated to perform template matching for all partial areas Qi. Thus, for each partial area R₁, maximum matching score Cimax and movement vector Vi are calculated.

Calculation unit 1045 stores to memory 102 at a predetermined address the maximum matching score Cimax and movement vector Vi successively calculated as described above for each of all partial areas Qi, and thereafter signals control unit 109 that the template matching ends to complete the process.

Subsequently control unit 109 signals similarity score calculation unit 106 to start a similarity score calculation, and waits until it is signaled that the calculation completes. Similarity score calculation unit 106 reads from memory 102 information such as movement vector Vi and maximum matching score Cimax of each partial area Qi, as obtained by the template matching, and uses the information to calculates a similarity score through the process indicated in FIG. 8 at steps S109 through S122.

Herein the similarity score calculation process generally refers to a process employing a position of a maximum matching score corresponding to each of a plurality of partial images, as obtained in the aforementioned template matching process, to calculate similarity between images of two image data Ak and Ak+1. It will more specifically be described hereinafter. Generally, the data of snap shot images are data obtained from a single person, and therefore, the similarity score calculation process may not be performed. Hereinafter two similarity scores compared provide a result indicating that one is larger than the other it indicates that one has a higher level in similarity than the other, and if one is smaller than the other then such indicates that one has a lower level in similarity than the other.

In step S109, a similarity score P(Ak, Ak+1) is initialized to 0. Here, similarity score P(Ak, Ak+1) is a variable for storing the degree of similarity between the images of image data Ak and Ak+1. Accordingly in the following description it can also be referred to as a variable P(Ak, Ak+1).

In step S110, a subscript i of movement vector Vi to be used as a reference is initialized to 1. In step S111, a similarity score Pi concerning the reference movement vector Vi is initialized to 0. In step S112, a subscript j of a movement vector Vj is initialized to 1. In step S113, a vector difference dVij between reference movement vector Vi and movement vector Vj is calculated in accordance with the following equation (3):
dVij=|Vi−Vj|=sqt((Vix−Vjx)²+(Viy−Vjy)²) (3),
wherein variables Vix and Viy represent components of movement vector Vi in directions x and y, respectively, and variables Vjx and Vjy represent components of movement vector Vj in directions x and y, respectively, and a variable sqrt(X) is an expression calculating a square root of X and X ˆ 2 is an expression calculating a square of X.

In step S114, vector difference dVij between movement vectors Vi and Vj is compared with a predetermined constant ε to determine whether movement vectors Vi and Vj can be regarded as substantially identical vectors. If vector difference dVij is smaller than constant ε, movement vectors Vi and Vj are regarded as substantially identical vectors, and the process proceeds to step S115, otherwise the vectors are not determined as substantially identical vectors, and the process proceeds to step S116. In step S115, similarity score Pi is incremented in accordance with equations (4) to (6):
Pi=Pi+α (4)
α=1 (5)
α=Cjmax (6).

In equation (4), a variable α is a value for incrementing similarity score Pi. If α=1 is set, as represented by equation (5), similarity score Pi represents the number of partial areas that have the same movement vector as reference movement vector Vi. If α=Cjmax is set, as represented by equation (6), similarity score Pi represents a total sum Cjmax of maximum matching scores Cimax in template matching for partial areas that have the same movement vector as reference movement vector Vi. Furthermore the value of variable a may for example be reduced in accordance with the magnitude of vector difference dVij.

In step S116, a decision is made as to whether subscript j has a value smaller than the total number n of partial areas. If subscript j has a value smaller than the total number n of partial areas, the process proceeds to step S117. If subscript j has a value equal to or larger than the total number n of partial areas, the process proceeds to step S118. In step S117, the value of subscript j is incremented by 1, and the process returns to S113. By the process from steps S111 to S117, similarity score Pi is calculated using the information about partial areas determined to have the same movement vector as reference movement vector Vi. In step S118, similarity score Pi using movement vector Vi as a reference is compared with similarity score P(Ak, Ak+1). If the comparison provides a result indicating that similarity score Pi is larger than a currently maximum similarity score (the value of similarity score P(Ak, Ak+1)), the process proceeds to step S119, otherwise the process proceeds to step S120.

In step S119, the value of similarity score Pi with reference to movement vector Vi is set as variable P(Ak, Ak+1). In steps S118 and S119 whether reference movement vector Vi is appropriate as a reference is determined. More specifically, if similarity score Pi with reference to movement vector Vi is larger than a maximum value of a similarity score with reference to a different movement vector previously calculated (i.e., the value of variable P(Ak, Ak+1), reference movement vector Vi is regarded as the most appropriate reference vector among movement vectors Vi indicated by values, respectively, of subscript i, previously obtained as the subscript is incremented by one.

If similarity score Pi with reference to movement vector Vi is equal to or smaller than a maximum value of a similarity score with reference to a different movement vector previously calculated (i.e., the value of variable P(Ak, Ak+1) (No at S118), the process proceeds to S120 to compare the value of subscript i of reference movement vector Vi with the number of partial areas (i.e., the value of variable n). If the value of subscript i is smaller than the number n of partial areas (YES at S120), the process proceeds to step S121. In step S121, the value of subscript i is incremented by 1.

Through steps S109 to S121, a degree of similarity between the images of image data Ak and Ak+1 is calculated as a value of variable P(Ak, Ak+1). Similarity score calculation unit 106 stores the value of variable P(Ak, Ak+1) calculated in the above described manner to memory 102 at a predetermined address. Thereafter if a decision is made that variable i has a value equal to or larger than the total number of partial areas or the value of variable n (No at S120) then the process proceeds to S122 to calculate an average value Vk, k+1 of area movement vectors in accordance with the following equation (7):

$$Vk , k + 1 = ( {\sum }_{i = 1}^{n} Vi ) \text{/} n \qquad ( 7 )$$

and store the same to memory 102.

Here, average value Vk, k+1 of area movement vectors is calculated to obtain a relative, positional relation between the images of snap shot image data Ak and Ak+1, as based on an average value of a set of movement vectors Vi of respective partial areas Qi of each of the snap shot images. For example, with reference to FIGS. 10A and 10B, the average vector of area movement vectors V1 and V2 is given as a vector V12. Similarly, the average vector of area movement vectors V2 and V3 is given as a vector V23. The average vector of area movement vectors V3 and V4 is given as a vector V34. The average vector of area movement vectors V4 and V5 is given as a vector V45.

After average vector Vk, k+1 is obtained, similarity score calculation unit 106 signals control unit 109 that the calculation completes, and the process ends.

With reference again to FIG. 7, then, to movement vectors on memory 102 that are accumulated, or a vector Vsum, movement vector Vk, k+1 obtained at ST11 is added as a vector and a result thereof is set as a new value of Vsum (step T12).

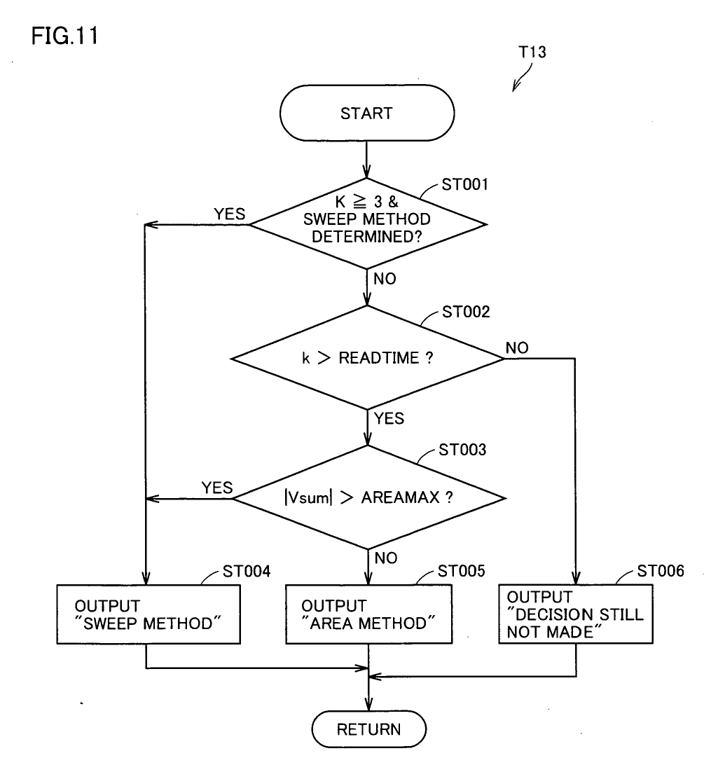

Then input and comparison method determination unit 1042 follows a flowchart shown in FIG. 11 to determine a method for inputting and comparing a fingerprint (step T13). This decision indicates one of the area sensing method, the sweep sensing method, and that a method that does not correspond to any of the area and sweep sensing methods (“decision still not made”). Note that step T13 can be replaced with step T13a or T13b as will be described later.

In FIG. 11, when steps T8-T15 as shown in FIG. 7 are looped a number of times larger than a predetermined number of times indicated by a variable READTIME a decision is made as to whether the sweep method or the area method is applied as a method for inputting and comparison. It is assumed that how many times steps T8-T15 are looped is counted by a counter (not shown) of input and comparison method determination unit 1042. Furthermore, comparison method data 111 indicating a result of determining a method for inputting and comparing a fingerprint is stored to memory 102. It is assumed that when the FIG. 6 process starts, comparison method data 111 in memory 102 has an initial value (for example “decision still not made”) preset.

Initially if the aforementioned counter indicates that steps T8-T15 are looped no less than three times and already in this process the “sweep method” is determined, i.e., k≧3 and comparison method data 111 read from memory 102 indicates the “sweep method”, input and comparison method determination unit 1042 determines the “sweep method” is (steps ST001, ST004). Otherwise, i.e., if a decision is made that variable k read from memory 102 has a value indicating a value of no more than variable READTIME then “decision still not made” is set in comparison method data 111 in memory 102 (or comparison method data 111 is updated) (steps ST002 and ST006). Whether a predetermined period of time has elapsed since inputting an image via fingerprint sensor 100 to image input unit 1 started, is determined (step ST002) by whether steps T8-T15 are lopped a number of times, as indicated by the counter, corresponding to a value of no less than that of variable READTIME.

If “decision still not made” is not determined (YES in step ST002), then the value of variable Vsum is read from memory 102 and a length |Vsum| of a cumulative movement vector indicated by its absolute value is calculated. The value of |Vsum| and a predetermined value indicated by a variable AREAMAX are compared with each other and if a result of the comparison indicates a value less than a predetermined value then the area method is determined and if the result of the comparison indicates a value of no less than the predetermined value then the sweep method is determined. The decision is set in comparison method data 111 stored in memory 102 (steps ST003-ST005). Subsequently the process returns to the previous process shown in FIG. 7. The predetermined value indicated by variable AREAMAX is a threshold value for determining that in area 199 of fingerprint sensor 100 a finger is moved while an image is read, and it is assumed that the value is obtained previously in an experiment and stored in memory 102.

If in step T14 comparison method data 111 with the step T13 decision set indicates the area method control unit 109 branches the process to step T16. If the data indicates the sweep method control unit 109 branches the process to step T15. If the data indicates “decision still not made” control unit 109 returns to step T8.

For the sweep method if in step T15 a decision is made that the total number of snap shot images Ak input (the value of variable k) is larger than a defined value indicated by a variable NSWEEP the control proceeds to step T16. If a decision is made that the total number is no more than the defined value the control returns to step T8. Variable NSWEEP indicates the number of snap shot images input required to obtain a predetermined level in precision for comparison for the seep method and is assumed to be previously obtained in an experiment and stored in memory 102.

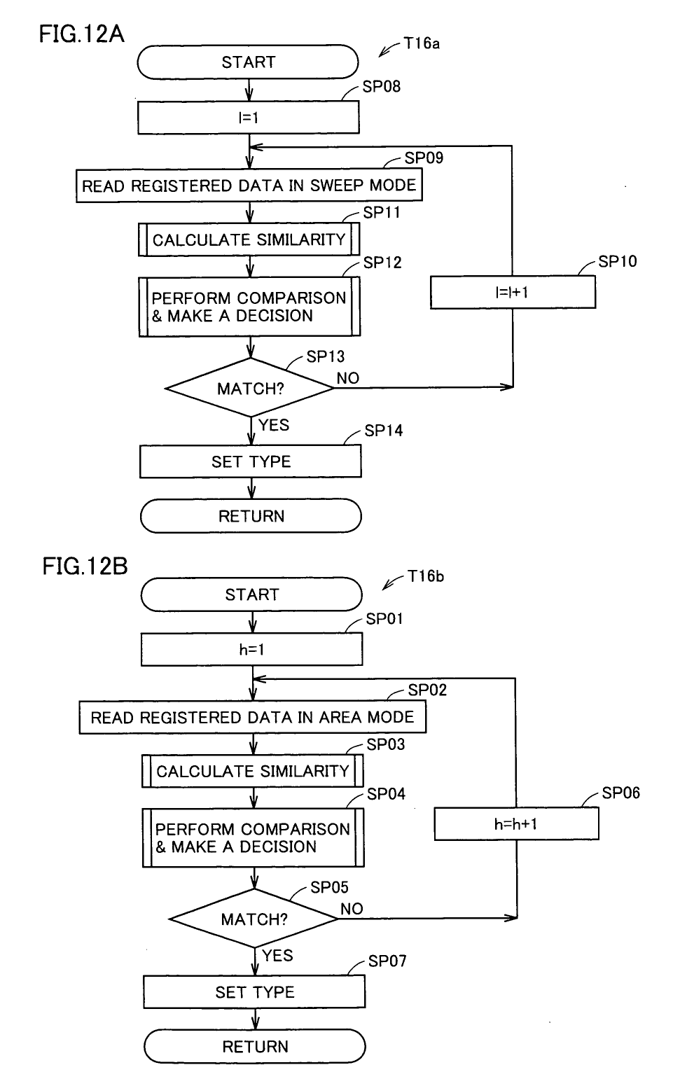

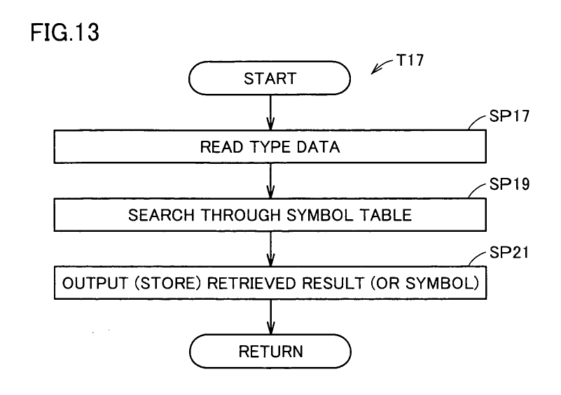

Control unit 109 then performs one of the image comparison processes of FIGS. 12A and 12B employing comparison process unit 11 that is selected by select unit 115 (steps T15a, T16a, T16b), and subsequently performs a symbol string generation process shown in FIG. 13 (step T17). Steps T1-T17 are repeated until a decision is made in step T18 that an instruction is received indicating that inputting information ends. (YES in step T18). It is assumed that this instruction is entered by a user for example operating keyboard 650. If a decision is made that such instruction is not received (NO in step T18) then the control returns to step T1 and thereafter similarly a process is repeated for inputting information.

An image comparison process employing table 200 or 201 (steps T16a, T16b) is shown in FIGS. 12A and 12B.

If in step T14 the sweep method is determined then in step T15a select unit 115 selectively activates varying-image comparing function unit 006 rather than still-image comparing function unit 005 and in step T16a varying-image comparing function unit 006 is employed to perform the process shown in FIG. 12A (step T15a). More specifically, the process of FIG. 12A is performed (or activated) for comparison of read varying image data in accordance with such a manner that area 199 of fingerprint sensor 100 and a finger (or fingerprint) have a varying, relative, positional relationship therebetween. In FIG. 12A initially control unit 109 signals registered-data reading unit 207 to start reading registered data in accordance with a mode determined in step T14 and waits until it is signaled that reading registered data ends.

When registered-data reading unit 207 is signaled to start reading registered data, registered-data reading unit 207 sets a variable l to be 1 for counting image data Bl of table 200 (step SP08). Variable l has a value indicating that of a subscript of image data Bl. Then image data Bl, which is reference image data, is read from table 200 of registered-data storage unit 202 in accordance with a method (the sweep method) indicated by comparison method data 111 of memory 102 (step SP02). Currently, variable l has a value of 1. Accordingly, image data Bl of table 200 is read. Image data Bl read provides an image, which will be referred to as a reference image B. Reference image B has a partial area Ri, and its data is read from image data Bl and stored to memory 102 at a predetermined address.

Thereafter variable l is incremented by one, while input image Ak and reference image B are compared. Until a result indicating that the two images match is output (YES in step SP13) reading and comparing with reference image data Bl is repeated.

If in step T14 the area method is determined then in FIG. 7 at step T15a select unit 115 selectively activates still-image comparing function unit 005 rather than varying-image comparing function unit 006 and in step T16b still-image comparing function unit 005 is employed to perform the process shown in FIG. 12B. More specifically, the process of FIG. 12B is performed for comparison of read varying image data in accordance with such a manner that area 199 of fingerprint sensor 100 and a finger (or fingerprint) have an unchanged (or fixed), relative, positional relationship therebetween. In the FIG. 12B process image data Bh for reference image B is read from table 201 with a variable h indicative of a value of a subscript incremented by one (steps SP01, SP02 and SP06). The remainder of the process is identical to that of FIG. 12A.

Both image data Ak and image data B are employed to perform a comparison process and makes a decision. This process will be described for a process performed when the area method is determined (steps SP03, SP04) and that performed when the sweep method is determined (step SP11, SP12).

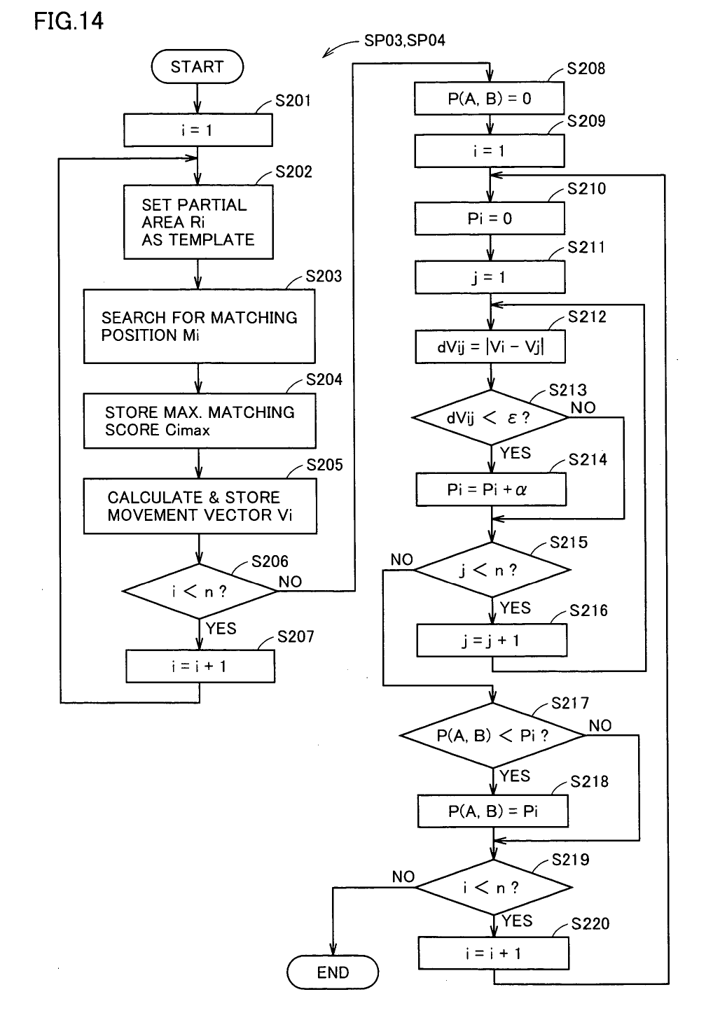

Image data Ak input is assumed to be image data A, and image data A and image data B for that the area method is determined are subjected to a comparison process (steps SP03, SP04) in a procedure as will now be described with reference to FIG. 14 showing a flowchart.

Control unit 109 signals position search unit 105 to start template matching, and awaits until it is signaled that the template matching ends. Position search unit 105 starts such a template matching process as indicated in steps S201 through S207.

The template matching process as performed herein is a process performed for example to obtain to which of partial area M1, M2, . . . , Mn of FIG. 21B partial areas R1, R2, . . . , Rn of FIG. 21A have moved.

Initial in step S201 the counter has variable i initialized to 1. In step S202 an image of a partial area defined as partial area Ri from the image of image data A is set as a template to be used for the template matching.

Although partial area Ri set in the image of image data A is rectangular for simplifying the calculation, it is not limited thereto. In step S203, a location in the image of image data B having the highest score of matching with the template set in step S202, that is, a portion, within the image, at which the data best matches therewith, is searched for. More specifically, the pixel density of coordinates (x, y) with reference to the upper left corner of the partial area Ri used as the template is represented as Ri (x, y). The pixel density of coordinates (s, t) with reference to the upper left corner of the image of image data B is represented as B (s, t). The width and height of the partial area Ri are represented as w and h, respectively. A possible maximum density of each pixel in image data A and B is represented as V0. Then, matching score Ci (s, t) at coordinates (s, t) in the image of image data B is calculated in accordance for example with the following equation (8):

$$Ci ( s , t ) = {\sum }_{y = 1}^{h} {\sum }_{x = 1}^{w} ( V 0 - \vert Ri ( x , y ) - B ( s + x , t + y ) \vert ) , \qquad ( 8 )$$

as based on a difference in density of each pixel.

In the image of image data B, the coordinates (s, t) are successively updated and matching score C (s, t) at the coordinates (s, t) is calculated. A position having the highest matching score is considered as the position with the maximum matching score, the image of the partial area at that position is represented as partial area Mi, and the matching score at that position is represented as maximum matching score Cimax. In step S204, maximum matching score Cimax in the image of image data B of partial area Ri that is calculated in step S203 is stored to memory 102 at a predetermined address. In step S205, movement vector Vi is calculated in accordance with the following equation (9):
Vi=(Vix, Viy)=(Mix−Rix, Miy−Riy) (9)
and stored to memory 102 at a predetermined address.

Here, as has been described hereinbefore, if as based on the partial area Ri corresponding to position P set in the image of image data A, the image of image data B is scanned to locate partial area Mi at position M having the highest score of matching with the partial area Ri, a directional vector from position P to position M is herein referred to as a movement vector. This is because when one image, e.g., that of image data A is set as a reference the other image, e.g., that of image data B appears to have moved as a finger may be placed on fingerprint sensor 100 at area 199 differently.

In equation (9), variables Rix and Riy are x and y coordinates of a reference position of partial area Ri, and correspond, by way of example, to the coordinates of the upper left corner of partial area Ri in the image of image data A. Furthermore variables Mix and Miy are x and y coordinates of the position of maximum matching score Cimax that is obtained as a result of the search for partial area Mi, and correspond, by way of example, to the coordinates of the upper left corner of partial area Mi at a matching position in the image of image data B (see FIGS. 10C and 10D).

In step S206, the counter's variable i is compared with the total number n of partial areas to determine whether i<n is established. If so (YES at S206) the process proceeds to step S207, otherwise (NO at S206) the process proceeds to step S208. In step S207, variable i is incremented by one. Thereafter, while variable i is smaller than the total number n of partial areas, steps S202 to S207 are repeated. In this repetition all partial areas Ri are subjected to the template matching and for each partial area Ri maximum matching score Cimax and movement vector Vi are calculated.

Position search unit 105 stores to memory 102 at a predetermined addresses the maximum matching score Cimax and movement vector Vi calculated for every partial area Ri as described above, and thereafter signals control unit 109 that the template matching ends to complete the process.

Subsequently control unit 109 signals similarity score calculation unit 106 to start a similarity score calculation, and waits until it is signaled that the calculation completes. Similarity score calculation unit 106 uses such information as movement vector Vi and maximum matching score Cimax for each partial area Ri obtained by the template matching and stored in memory 102 to calculate a similarity score of the images of image data A and B through a process indicated in steps S208 to S220. This process is the same as that described with reference to FIG. 9, and accordingly will simply be described.

The similarity calculation process as performed herein is, for example as shown in FIG. 21C, a calculation process performed to determine whether a large number of two-dimensional movement vectors indicated by (x, y) in connection with a partial area fall within a predetermined range of a vector space (a two-dimensional space) in which the two-dimensional vectors extend. This two-dimensional space is a plane coordinate defined by orthogonal x and y axes, and movement vector Vi has a component indicated by employing coordinates (x, y) in the plane coordinate.

In step S208, a similarity score P(A, B) is initialized to 0. Here, similarity score P(A, B) is a variable for storing a degree in similarity between the images of image data A and B. As such, similarity score P(A, B) may also be referred to as a variable P(A, B).

In step S209, subscript i of movement vector Vi to be used as a reference is initialized to 1. In step S210, similarity score Pi concerning the reference movement vector Vi is initialized to 0. In step S211, a subscript j of movement vector Vj is initialized to 1. In step S212, vector difference dVij between reference movement vector Vi and movement vector Vj is calculated in accordance with the following equation (10):
dVij=|Vi−Vj|=sqrt((Vix−Vjx)²+(Viy−Vjy)²) (10),
wherein: variables Vix and Viy represent components in directions x and y parallel to x and y axes, respectively, of movement vector Vi (a two dimensional vector); variables Vjx and Vjy represent components in directions x and y, respectively, of movement vector Vj; and variable sqrt(X) is an expression calculating a square root of X.

In step S213, vector difference dVij between movement vectors Vi and Vj is compared with the predetermined constant ε to determine whether movement vectors Vi and Vj can be regarded as substantially identical vectors. More specifically if the comparison provides a result indicating that vector difference dVij is smaller than constant ε, movement vectors Vi and Vj are regarded as substantially identical vectors (YES in step S213), and the process proceeds to step S214. If difference dVij equal to or larger than constant ε is indicated, the movement vectors are not regarded as substantially identical vectors (NO in step S213), and the process proceeds to step S215. In step S214, similarity score Pi is incremented in accordance with the following equations (11) to (13):
Pi=Pi+α (11)
α=1 (12)
α=Cjmax (13).

In equation (11), variable α is a value for incrementing similarity score Pi. If α=1 is set, as represented by equation (12), similarity score Pi represents the number of partial areas that have the same movement vector as reference movement vector Vi. If α=Cjmax is set, as represented by equation (13), then similarity score Pi represents the total sum of the maximum matching scores obtained in the template matching for partial areas that have the same movement vector as reference movement vector Vi. Furthermore the value of variable α may for example be reduced in accordance with the magnitude of vector difference dVij.

In step S215, subscript j is compared with the total number n of partial areas and if the comparison provides a result indicating that j<n is established (YES in step S215) the process proceeds to step S216, otherwise (NO in step S215) the process proceeds to step S217. In step S216, the value of subscript j is incremented by 1. By the process from steps S210 to S216, similarity score Pi is calculated using the information about partial areas determined to have the same movement vector as reference movement vector Vi. In step S217, similarity score Pi calculated with reference to movement vector Vi as a reference is compared with variable P(A, B). If the comparison provides a result allowing a decision to be made that similarity score Pi is larger than the highest similarity score (the value of variable P(A, B)) obtained by that time (YES in step S217), the process proceeds to step S218, otherwise (NO in step S217) the process proceeds to step S219.

In step S218, the value of similarity score Pi with reference to movement vector Vi is set as variable P(A, B). In steps S217 and S218, if similarity score Pi with reference to movement vector Vi is compared with the maximum value of the similarity score (the value of variable P(A, B)) calculated by that time with reference to other movement vectors and the comparison provides a result indicating that P(A, B)<Pi (YES in step S217), reference movement vector Vi is regarded as the most appropriate reference vector among movement vectors Vi indicated by subscript i that have been used.

In step S219, the value of subscript i of reference movement vector Vi is compared with the total number of partial areas (the value of variable n). If the comparison provides a result indicating that i<n (YES in step S219) the process proceeds to step S220. Otherwise (NO in step S219) the process ends. In step S220, the value of subscript i is incremented by 1, and thereafter the process returns to step S210.

Through steps S208 to S220, the degree of similarity between the images of image data A and B is calculated as the value of variable P(A, B). Similarity score calculation unit 106 stores the value of variable P(A, B) thus calculated to memory 102 at a predetermined address, and signals control unit 109 that a similarity score calculation completes.

With reference again to FIG. 12B, control unit 109 signals comparison and determination unit 107 to start comparison and making a decision, and waits until it is signaled that the comparison and decision-making completes. Comparison and determination unit 107 performs the comparison and makes the decision (step SP04). More specifically, the similarity score represented by the value of variable P (A, B) stored in memory 102 is compared with a predetermined comparison threshold T. If the comparison provides a result indicating that variable P(A, B)≧T is established (i.e., if a decision is made that the images of image data A and B are obtained from a single fingerprint) then as a result of the comparison a value indicating a “match”, e.g., “1” is written to memory 102 at a predetermined address. If the comparison provides a result indicating that variable P(A, B)≧T is not established (i.e., if a decision is made that the images of image data A and B are obtained from different fingerprints, respectively) then as a result of the comparison a value indicating a “mismatch”, e.g., “0” is written to memory 102 at a predetermined address. Thereafter, comparison and determination unit 107 signals control unit 109 that the comparison and decision-making completes.

In step SP05 registered-data reading unit 207 reads data stored in step SP04 by comparison and determination unit 107 to memory 102 at the predetermined address. If a decision is made that the read data indicates ‘1’ (a match) (YES in step SP05), the process proceeds to step SP07. If a decision is made that the read data indicates ‘0’ (a mismatch) (NO in step SP05) the process proceeds to step SP06. In step SP06 variable h is incremented by one. Subsequently the process returns to step SP02 and the process following step SP02 is similarly repeated.

In step SP07 registered-data reading unit 207 reads from table 201 type data Ti corresponding to image data Bh for which a ‘match’ is determined, and stores the read type data Ti as type data 112 to memory 102. Subsequently the process returns to that of FIG. 7.

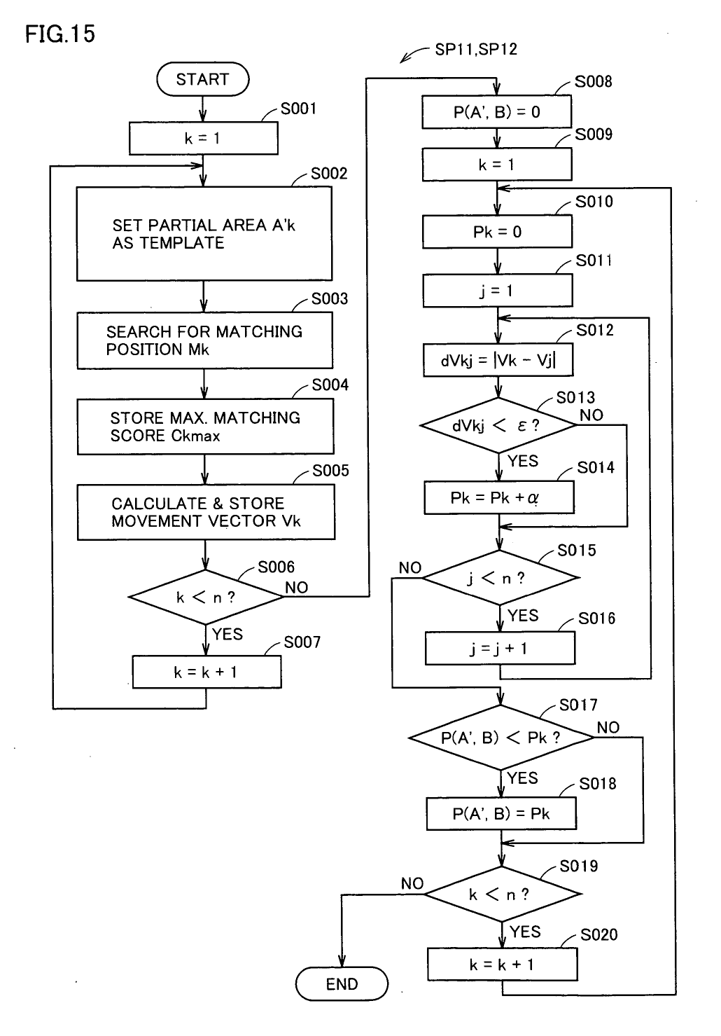

In the sweep mode when, as shown in FIG. 12A in steps SP11 and SP12, a similarity calculation is performed, and a comparison is done and a decision is made, a process is performed, as will now be described hereinafter with reference to FIG. 15 showing a flowchart.

Control unit 109 signals position search unit 105 to start template matching, and waits until it is signaled that the template matching completes. Position search unit 105 starts such a template matching process as indicated in steps S001 to S007.

The template matching process as performed herein is a process performed to search for a position of each maximum matching score indicating a position of an image of a partial area in which each of snap shot images of a set reflecting a reference position calculated by calculation unit 1045 calculating a relative, positional relationship attains a maximum matching score in an image different from the snap shot images of the set. Hereinafter the process will be described more specifically.

In step S001, the counter's variable k is initialized to 1. Variable k is referenced as a subscript specifying each data being processed as shown in FIG. 15. In step S002 a sum Pk of average values Vk, k+1 of area movement vectors is added to a coordinate provided with reference to the upper left corner of an image of snap shot image data A (corresponding to snap shot image data Ak) to obtain a coordinate A′k, which defines a partial area A′k, and its image data is set as a template employed in template-matching. Herein sum Pk is defined by an equation (14). Partial area A′k is also referred to as image data A′k.

$$Pk = {\sum }_{i = 1}^{i - 1} Vi - 1 , i \qquad ( 14 )$$

In step S003, a location in the image of image data B having the highest score of matching with the template set in step S002, that is, a portion, within the image, at which the data matches with the template to the highest degree, is searched for. More specifically, the pixel density of coordinates (x, y) with reference to the upper left corner of a partial area indicated by image data A′k used as the template is represented as A′k (x, y), the pixel density of coordinates (s, t) with reference to the upper left corner of the image of image data B is represented as B (s, t), the width and height of partial area A′k are represented as w and h respectively, and a possible maximum density of each pixel of image data A′k and B is represented as V0. Then, the matching score Ci (s, t) at coordinates (s, t) of image B is calculated according for example to the following equation (15):

$$Ci ( s , t ) = {\sum }_{y = 1}^{h} {\sum }_{x = 1}^{w} ( V 0 - \vert {A}^{′} k ( x , y ) - B ( s + x , t + y ) \vert ) , \qquad ( 15 )$$

as based on the difference in density of each pixel.

In the image of image data B, coordinates (s, t) are successively updated and the matching score C (s, t) at the coordinates (s, t) is calculated. A decision is made that the position of coordinates (s, t) having a matching score C (s, t) having a largest value among matching scores C (s, t) calculated is considered as the position with the maximum matching score, and the image of the partial area at that position is represented as a partial area Mk and the matching score C (s, t) at that position is set as a variable Ckmax indicating the maximum matching score. In step S004, the maximum matching score Ckmax in the image indicated by image data B of the partial area indicated by image data A′k as calculated in step S003 is stored to memory 102 at a predetermined address. In step S005, a movement vector Vk is calculated in accordance with the following equation (16):
Vk=(Vkx, Vky)=(Mkx−A′kx, Mky−A′ky) (16)
and stored to memory 102 at a predetermined address.

Here, as has been described above, if as based on a partial area corresponding to position P set in the image of image data A′k the image of image data B is scanned to locate partial area Mk of image data of position M having the highest score of matching with that partial area then a directional vector from position P to position M is herein referred to as a movement vector. This is because when one image, e.g., that of image data Ak is set as a reference the other image, e.g., that of image data B appears to have moved, since a finger may be placed on fingerprint sensor 100 at area 199 differently.

In equation (16), variables A′kx and A′ky indicate x and y coordinates of a reference position of a partial area indicated by image data A′k, which is a coordinate with reference to the upper left corner of snap shot image data Ak with a sum Pn of average values Vk, k+1 of area movement vectors added thereto. Variables Mkx and Mky are x and y coordinates of a position of maximum matching score Ckmax that is obtained as a result of the search for the partial area indicated by image data A′k. For example, it corresponds to the coordinates of the upper left corner of partial area Mk at the matching position in the image of image data B.

In step S006, whether the counter's variable k is smaller than the total number n of partial areas. If variable k is smaller than the total number n of partial areas (YES in step S006), the process proceeds to step S007, otherwise (NO in step S006), the process proceeds to step S008. In step S007, variable k is incremented by one. Thereafter, while variable k is smaller than the total number n of partial areas, steps S002 to S007 are repeated. In the repetition all partial areas A′k are subjected to template matching and for each partial area A′k maximum matching score Ckmax and movement vector Vk are calculated.

Position search unit 105 stores to memory 102 at a predetermined address the maximum matching score Ckmax and movement vector Vk thus calculated for every partial area A′k and thereafter signals control unit 109 that the template matching completes, and the process thus completes.

Subsequently, control unit 109 signals similarity score calculation unit 106 to start a similarity score calculation, and waits until it is signaled that the calculation completes. Similarity score calculation unit 106 uses such information as movement vector Vk and maximum matching score Ckmax of each partial area A′k obtained by the template matching and stored in memory 102 to calculate a similarity score through the process indicated in FIG. 14 in steps S008 to S020.

The similarity score calculation process as performed herein is as follows: initially it uses a position of a maximum matching score searched for in the aforementioned template matching process between each of snap shot images of a set and another image different from the snap shot images of the set. The position of such maximum matching score is searched for by employing a reference position previously calculated by calculation unit 1045 calculating a relative, positional relationship. A calculation is performed to determine whether an amount indicating a positional relationship between positions of maximum matching scores corresponding to each partial area thus searched falls within a predetermined threshold value, and from an obtained result of the calculation, similarity is determined, and therefrom, whether the snap shot images of the set match another image is determined. Such similarity calculation process will more specifically be described hereinafter.

In step S008, a similarity score P(A′, B) is initialized to 0. Here, similarity score P(A′, B) is assumed to be a variable for storing the degree of similarity between the image of image data A′ of a single snap shot image and that of image data B. As such, P(A′, B) can also be referred to as a variable P(A′, B). In step S009, subscript i of movement vector Vk to be used as a reference is initialized to 1. In step S010, a similarity score Pk concerning the reference movement vector Vk is initialized to 0. In step S011, subscript j of movement vector Vj is initialized to 1. In step S012, vector difference dVkj between reference movement vector Vk and movement vector Vj is calculated in accordance with the following equation (17):
dVkj=|Vk−Vj|=sqrt((Vkx−Vjx)²+(vky−Vjy)²) (17),
wherein variables Vkx and Vky represent components in directions x and y, respectively, of movement vector Vk and variables Vjx and Vjy represent components in directions x and y, respectively, of movement vector Vj, and variable sqrt(X) is an expression calculating a square root of X.

In step S013, vector difference dVkj between movement vectors Vk and Vj is compared with constant ε to determine whether movement vectors Vk and Vj can be regarded as substantially identical vectors. If vector difference dVkj is smaller than constant ε, movement vectors Vk and Vj are regarded as substantially identical vectors, and the process proceeds to step S014. If the difference is equal to or larger than the constant, the movement vectors are not regarded as substantially identical vectors, and the process proceeds to step S015. In step S014, similarity score Pk is incremented in accordance with the following equations (18) to (20):
Pk=Pk+α (18)
α=1 (19)
α=Ckmax (20).

In equation (18), variable α is a value for incrementing similarity score Pk. If α=1 is set, as represented by equation (19), similarity score Pk represents the number of partial areas that have the same movement vector as reference movement vector Vk. If α=Ckmax is set, as represented by equation (20), similarity score Pk represents the total sum of the maximum matching scores in the template matching for partial areas that have the same movement vector as reference movement vector Vk. The value of variable α may for example be reduced in accordance with the magnitude of vector difference dVkj.

In step S015, whether subscript j has a value smaller than the total number n of partial areas, is determined. If so the process proceeds to step S016, otherwise the process proceeds to step S017. In step S016, subscript j is incremented by 1. By the process from steps S010 to S016, similarity score Pk is calculated using the information about partial areas determined to have the same movement vector as reference movement vector Vk. In step S017, similarity score Pk with movement vector Vk serving as a reference is compared with variable P(A′, B). If the comparison provides a result from which a decision is made that similarity score Pk is larger than the highest similarity score (the value of variable P(A′, B)) of those previously calculated, the process proceeds to step S018, otherwise the process proceeds to step S019.

In step S018, the value of similarity score Pk with reference to movement vector Vk is set as variable P(A′, B). In steps S017 and S018, if similarity score Pi with reference to movement vector Vk is larger than the maximum value of the similarity score (the value of variable P(A′, B)) calculated by that time with reference to other movement vectors, reference movement vector Vk is determined as the most appropriate reference vector among movement vectors Vk indicated by subscript k that have been used.

In step S019, the value of subscript k of reference movement vector Vk is compared with the total number of partial areas (the value of variable n). If the comparison provides a result from which a decision is made that the value of subscript k is equal to or larger than the total number of partial areas, the process ends. Otherwise the process proceeds to step S020. In step S020, subscript (or variable) k is incremented by 1.

Through steps S008 to S020, the degree of similarity between the images of image data A′ and B is calculated as the value of variable P(A′, B). Similarity score calculation unit 106 stores to memory 102 at a predetermined address the value of variable P(A′, B) thus calculated indicating a similarity score, and signals control unit 109 that a similarity score calculation ends to complete the process.

With reference again to FIG. 12A, subsequently control unit 109 signals comparison and determination unit 107 to start comparison and making a decision, an d waits until it is signaled that the comparison and decision-making has been done. Comparison and determination unit 107 performs the comparison and makes the decision (step SP12). More specifically, the similarity score represented by the value of variable P(A′, B) stored in memory 102 is compared with the predetermined comparison threshold T. if from a result of the comparison a decision is made that variable P(A′, B)≧T is satisfied, a decision is made that the images of image data A′ and B are obtained from a single fingerprint, then as a result of the comparison a value indicating a “match”, e.g., “1” is written to memory 102 at a predetermined address. Otherwise a decision is made that the images are obtained from different fingerprints, respectively, and as a result of the comparison a value indicating a “mismatch”, e.g., “0” is written to memory 102 at a predetermined address. Thereafter, comparison and determination unit 107 signals control unit 109 that the comparison and decision-making ends to complete the process.

In step SP13 registered-data reading unit 207 reads data stored in step SP12 to memory 102 at the predetermined address. If a decision is made that the read data indicates ‘1’ (a match), the process proceeds to step SP14. If a decision is made that the read data indicates ‘0’ (a mismatch) the process proceeds to step SP10. In step SP10 variable l is incremented by one. Subsequently the process returns to step SP09 and the process following step SP09 is similarly repeated.

In step SP14 registered-data reading unit 207 reads from table 200 type data Uj corresponding to image data Bl for which a ‘match’ is determined, and stores the read type data Uj to memory 102 as type data 112. Subsequently the process returns to that of FIG. 7.

When the FIG. 12A or 12B process thus ends and type data 112 is stored, symbol generation unit 108 performs step T17 shown in FIG. 7.

Step T17 will now be described more specifically with reference to FIG. 13. Initially in step SP17 symbol generation unit 108 reads type data 112 from memory 102. Then, in step SP19, as based on type data 112 read, table 110 is searched to read a symbol of a consonant of the item ‘row’ and a symbol of a vowel of the item ‘column’ that correspond to type data 112 read. Symbol generation unit 108 stores the pair of the symbols of the consonant and vowel read to memory 102 at buffer 113 as symbol data 114.

A symbol string generation process (T17) thus ends and whether an input ends or not is determined (T18). If a decision is made that the input ends, the series of the steps of the process of FIG. 7 ends. If a decision is not made that the input ends, the process returns to step T1, and inputting a fingerprint image and employing an input image to perform a conversion to a symbol are repeated. This stores to buffer 113 a set of a symbol of a consonant and that of a vowel (or a set of a symbol of a vowel and a symbol of a vowel for the “A” row) for each fingerprint image received from fingerprint sensor 100. The set is stored to buffer 113 in an order in which it is input. Accordingly, when the FIG. 7 process ends, an electronic mail editing function performs ‘kana’ conversion, as based on what is stored in buffer 113, in accordance with the conventionally known 50-sound chart, and electronic mail is edited using a ‘kana’ character obtained through the conversion. What is edited is displayed by display 610, and the user can confirm what is input and a result of converting the same.

The present embodiment can provide such an effect as follows: for example if for the FIG. 3A or 3B mobile phone 2, keyboard 650 is operated, as conventional, to input five characters “A, I, U, E, O” in accordance with the arrangement of the kanas in the 50-sound chart, a key 651 of keyboard 650 must be operated once to input “A”, twice to input “I”, three times to input “U”, four times to input “E”, and five times to input “O”, i.e., the user is required to operate the key 15 times in total.

In the present embodiment, in contrast, the user is required to perform an operation twice for each of “A”, “I”, “U”, “E”, “O”, i.e., ten times in total, for reading fingerprint images. The present embodiment can thus provide a method that only requires 10/15≈67% of the amount of an inputting operation (or a number of times of such operation) performed by conventionally operating keyboard 650 and thus reduces such amount by approximately 33%.

Conversion to Another Symbol

As the aforementioned process searching table 110 and providing conversion into a symbol (or reading a symbol) assumes converting in accordance with the 50-sound chart unique to the Japanese language. Accordingly, the FIG. 6 table 110 has the item (Ti, Uj), with an element having a value indicating only a value corresponding to a fingerprint of a right hand. More specifically, the conversion is performed with an image of a fingerprint of a right hand alone used as an image input. However, an image of a fingerprint of a left hand may also be used as an image input. Previously preparing storing a table similar to FIG. 6 for symbol conversion for a fingerprint of a left hand and storing the table in memory 102 allows an input to be also converted for example to an alphabet, numerals, symbols such as “+”, “−”, “*” and the like.

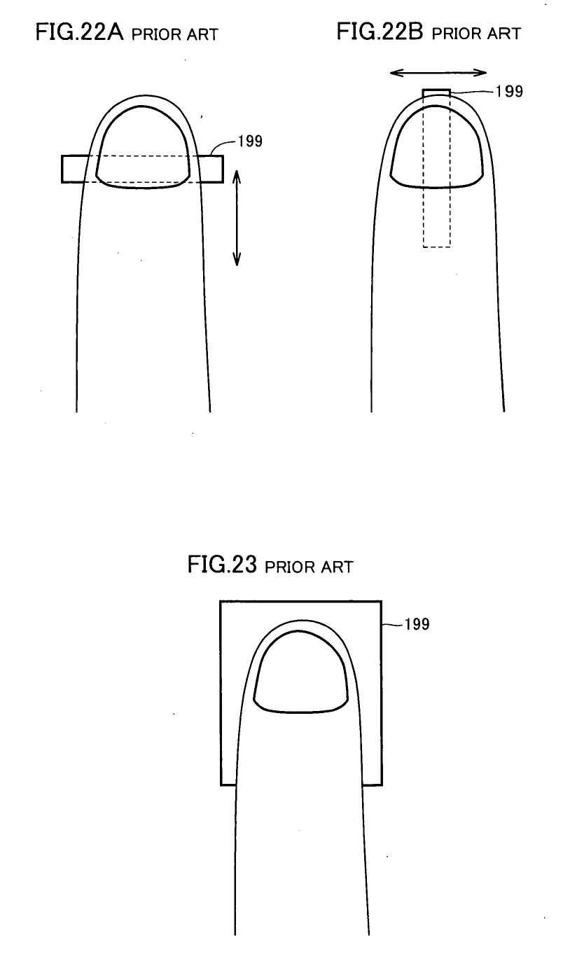

Furthermore in inputting a fingerprint for the sweep mode the fingerprint and area 199 have a varying, relative, positional relationship therebetween. More specifically, as a finger moves on area 119 rightward and leftward, fingerprint sensor 100 (or area 199) and an object to be read, or a fingerprint, have a relative, positional relationship therebetween varying in time series. More specifically, this indicates that if it is assumed that area 199 is fixed, the position of the fingerprint moves leftward or rightward relative to area 199 and that if it is assumed that the fingerprint is fixed and area 199 moves, then the position of area 199 moves leftward or rightward relative to the fingerprint. While a fingerprint and area 199 thus have a horizontally varying, relative, positional relationship therebetween for the sake of illustration, they may alternatively have a vertically varying, relative, positional relationship therebetween as shown in FIG. 22A.

Furthermore adaptation may be made to allow a fingerprint to be input in the sweep method in any of vertical and horizontal directions. This allows furthermore more types of symbols to be input.

In the present embodiment, image correction unit 104, calculation unit 1045 calculating a relative, positional relationship, position search unit 105, similarity score calculation unit 106, comparison and determination unit 107 and control unit 109 may all or partially be implemented by memory 624 or similar ROM having a process procedure stored therein as a program and CPU 622 or a similar processor controller.

### Second Embodiment

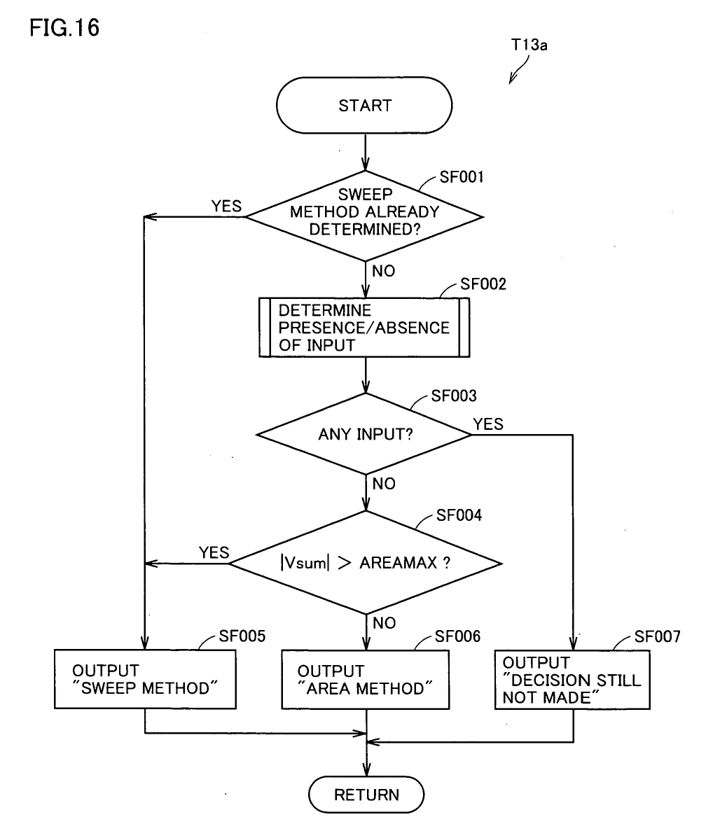

A second embodiment describes determining a method of inputting a fingerprint and of comparison as shown in FIG. 7, in a different procedure (step T13a). This procedure will now be described with reference to FIG. 16 showing a flowchart. In the first embodiment, as shown in FIG. 11, when steps T8-T15 are looped a number of times larger than a predetermined number of times indicated by variable READTIME, making a decision is started to determine the sweep method or the area method. When such decision making should be started is, however, not limited thereto. For example, as shown in FIG. 16, the sweep method or the area method may be determined when a finger is removed from area 199 of fingerprint sensor 100 of image input unit 101, i.e., when inputting an image ends.

With reference to FIG. 16, initially if steps T8-T15 are looped for the second or subsequent time and already in this process the sweep method is determined, input and comparison method determination unit 1042 determines the sweep method (steps SF001, SF005).

Otherwise, similarly as described for the FIG. 8 process (or step T3), image data Ak+1 is processed and from a result thereof whether there is an input or not is determined (step SF002). If a decision is made that there is an input (YES in step SF003) then “decision still not made” is determined (step SF007). “There is an input” as referred to herein indicates that a finger is placed in contact with area 199 of fingerprint sensor 100 of image input unit 101.

If a decision is made that there is not an input (NO in step SF003) then the value of vector variable Vsum on memory 102 is referenced and its length |Vsum| is calculated. If a decision is made that the calculated value indicates a value equal to or smaller than a predetermined value of variable AREAMAX (NO in step SF004) the area method is determined (step SF006), otherwise (YES in step SF004) the sweep method is determined (SF005).

A signal corresponding to each determined method is transmitted to control unit 109. Subsequently, the FIG. 16 process for determining a method of inputting a fingerprint and of comparison is completed and the control returns to the previous process shown in FIG. 7.

### Third Embodiment

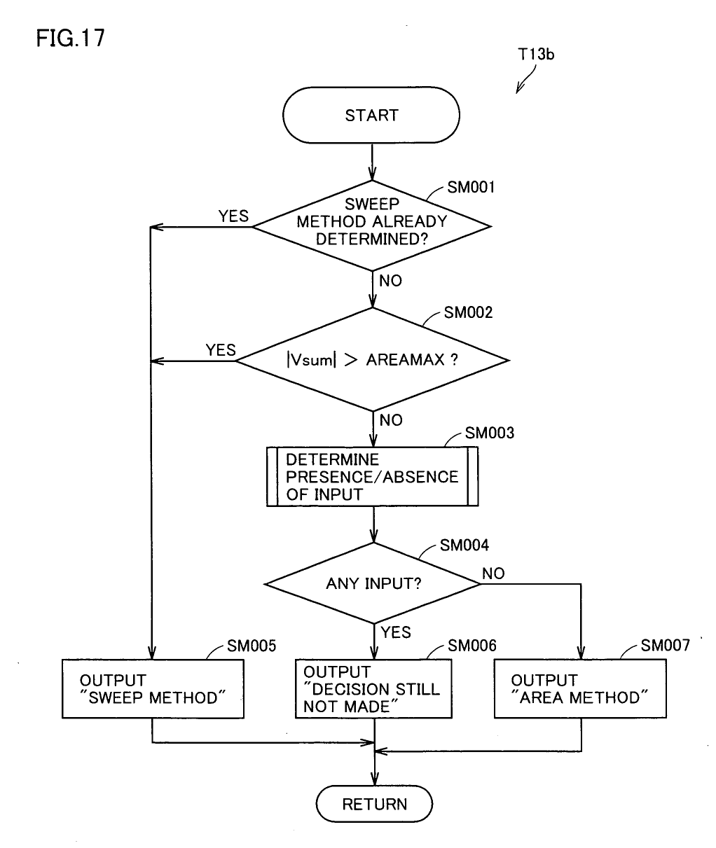

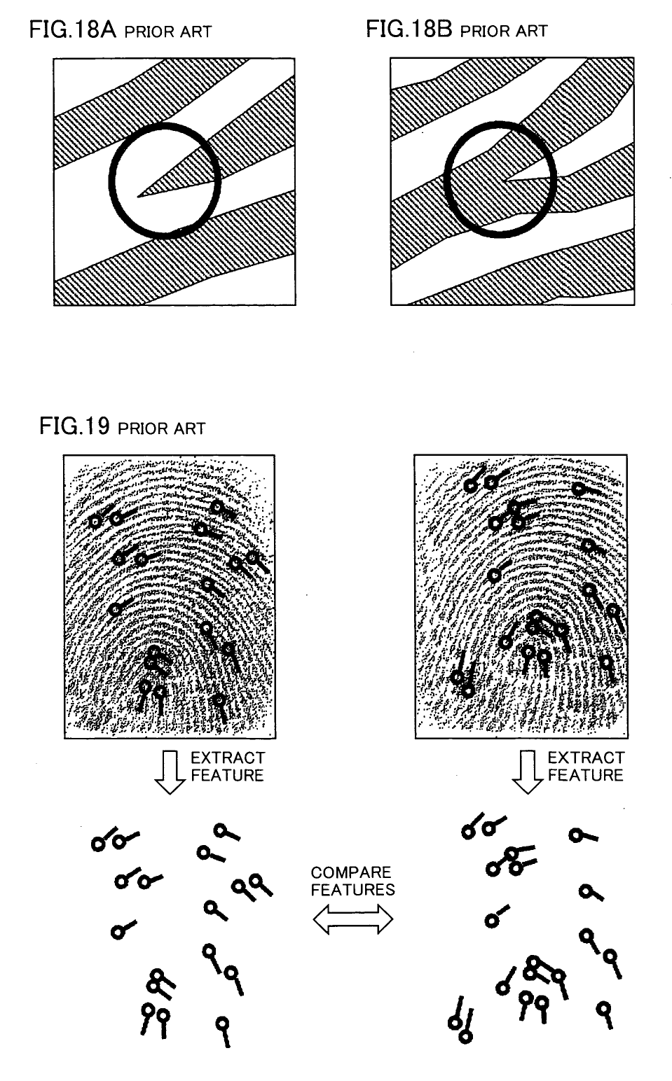

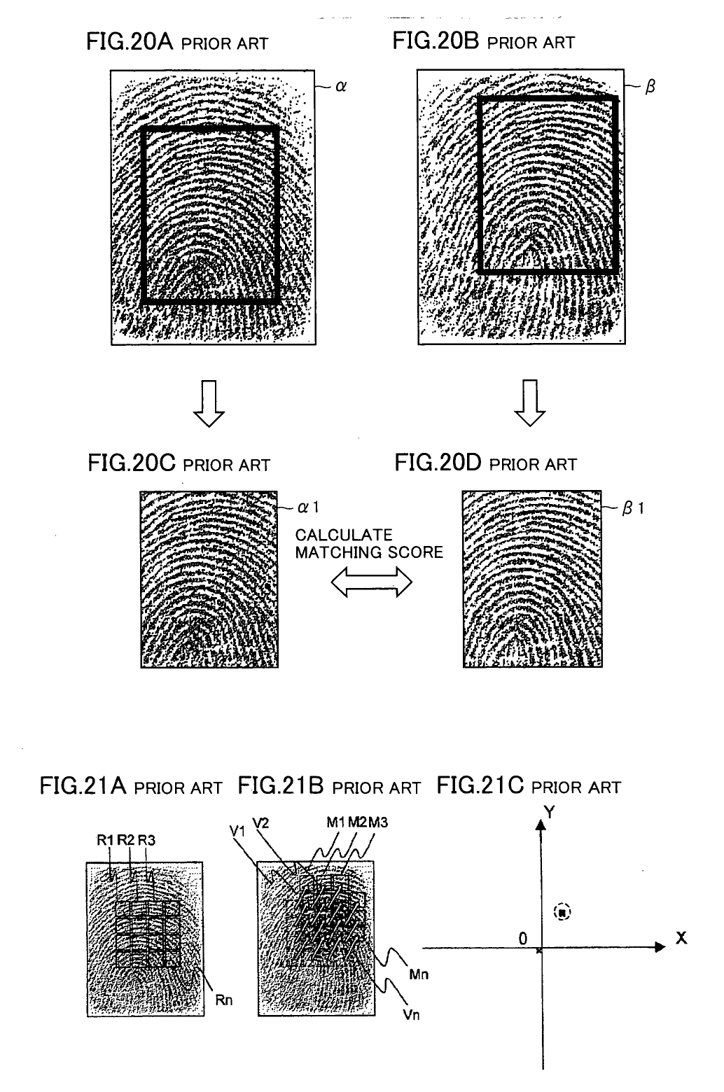

The process for determining a method of inputting a fingerprint and of comparison, as described in the first embodiment, is performed in still another procedure (step T13b), as shown in FIG. 17.

In the first embodiment either the sweep method or the area method is determined when steps T8-T15 are looped a number of times larger than a predetermined number of times indicated by variable READTIME. Furthermore in the second embodiment either the sweep method or the area method is determined when a finger is removed from area 199 of fingerprint sensor 100 of image input unit 101. Such decision making, however, is not limited to these procedures and may be done as described in a third embodiment.

In the third embodiment the sweep method is determined when a finger is placed in contact with area 199 of fingerprint sensor 100 of image input unit 101 and vector variable Vsum also indicates an amount of cumulative movement larger than a predetermined value, and the area method is determined when the finger is removed from area 199 and vector variable Vsum also indicates an amount of cumulative movement equal to or smaller than the predetermined value. This procedure will now be described with reference to FIG. 17 showing a flowchart.

Initially if steps T8-T15 are looped for the second or subsequent time and already in this process the sweep method is determined, input and comparison method determination unit 1042 determines the sweep method (steps SM001, SM005).

Otherwise, the value of vector variable Vsum on memory 102 is read and its absolute value |Vsum| is calculated. If a decision is made that the absolute value indicates a value equal to or smaller than a predetermined value indicated by variable AREAMAX, then, similarly as described for the FIG. 8 process (or step T3), image data Ak+1 is processed and whether there is an input or not is determined (step SM003). If a decision is made that the calculated absolute value is larger than the predetermined value indicated by variable AREAMAX, the sweep method is determined (step SM005).

If the step SM003 decision provides a result indicating that there is an input, “decision still not made” is determined. If the step SM003 decision provides a result indicating that there is no input, then the area method is determined (steps SM004, SM006, SM007).

A signal corresponding to each determined method is transmitted to control unit 109. The process for determining a method of inputting a fingerprint and of comparison as shown in FIG. 17 is completed and the control returns to the previous process shown in FIG. 7.

In each above described embodiment in conjunction with utilizing image comparison to generate information when a sweep sensing method and an area sensing method can be used in combination a combination of the distinction between these methods and a result of comparing images can be utilized to allow characters to be input more readily and conveniently than when an existing character or like inputting function is used. In particular, mobile equipment or the like including a mobile phone having a limited function to input characters and/or similar information, that has information generating apparatus 1 mounted therein allows an inputting function existing in the mobile equipment to be utilized to readily and conveniently input (or generate) information.

### Fourth Embodiment

The method of processing for image comparison and that of processing for generating information, as described above may be provided as a program. Such program may also be stored in a computer readable storage medium included in a computer, and thus provided as a program product.

For this storage medium, in the present embodiment, such a memory necessary for processing in the computer as shown in FIG. 2, as memory 624 or the like itself may be a program medium. Alternatively, the storage medium may be a storage medium detachably mounted on an external storage device of the computer and a program recorded thereon may be read through the external storage device. Such external storage device includes a magnetic tape device (not shown), FD drive 630 and CD-ROM drive 640 and the like, and the storage medium includes a magnetic tape (not shown), FD 632, CD-ROM 642, and the like. In any case, the program stored in each storage medium may be configured to be accessed and executed by CPU 622 or may once be read from the storage medium and loaded to a predetermined memory area shown in FIG. 2, such as a program memory area of memory 624, and then read and executed by CPU 622. The program for loading the aforementioned program is assumed to be stored in the computer in advance.

Here, the storage medium mentioned above is configured to be detachable from the main body of the computer. For such storage medium, a medium fixedly carrying the program is applicable.

More specifically, a magnetic tape, a cassette tape and other similar tapes; FD 632, fixed disk 626 and other similar magnetic disks; CD-ROM 642/a magnetic optical disc (MO)/a mini disc (MD)/a digital versatile disc (DVD) and other similar optical disks; an IC card (including a memory card)/an optical card and other similar cards; and semiconductor memory implemented by a mask ROM, an erasable and programmable ROM (EPROM), an electrically EPROM (EEPROM), a flash ROM or the like are applicable.

As The computer shown in FIG. 2 adopts a configuration that allows communicative connection to a communication network 300 including the Internet, the storage medium may be a storage medium carrying in a fluid manner the program, which is downloaded from communication network 300. If the program is downloaded from communication network 300, the program for downloading the aforementioned program may be stored in advance in the computer, or it may be installed in advance in the main body of the computer from a different storage medium.

What is stored in the storage medium is not limited to a program; it may be data.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information generating apparatus comprising:
an image input unit including a sensor and inputting image data of an object via said sensor;
a reference image storage unit storing reference image data to be compared with image data input by said image input unit,
a fixed-image comparison unit comparing said image data input by said image input unit in such a manner that said sensor and said object read by said sensor to provide an image have a fixed relative, positional relationship therebetween with said reference image data read from said reference image storage unit, and outputting a result of comparing said image data;
a varying-image comparison unit comparing said image data input by said image input unit in such a manner that said relative, positional relationship varies with said reference image data read from said reference image storage unit, and outputting a result of comparing said image data;
a determination unit making a decision from said image data input as to which one of said fixed-image comparison unit and said varying-image comparison unit should be employed to compare said image data input with said reference image data, and outputting a result of said decision;
a select unit selecting one of said fixed-image comparison unit and said varying-image comparison unit in accordance with decision data indicating said result of said decision output from said determination unit; and
an information generating unit generating information as based on said decision data and comparison result data indicating said result of comparing said image data output from one of said fixed-image comparison unit and said varying-image comparison unit as selected by said select unit.

2. The information generating apparatus according to claim 1, wherein said information generating unit converts said decision data and said comparison result data to previously associated said information.

3. The information generating apparatus according to claim 1, further comprising a table having said information stored therein in association with each of a plurality of sets of said decision data and said comparison result data, wherein said information generating unit reads from said table, as based on said decision data and said comparison result data, said information associated with one of said sets of said decision data and said comparison result data.

4. The information generating apparatus according to claim 1, wherein said image input unit inputs image data of said object via said sensor in one of such a manner that said sensor and said object have said relative, positional relationship therebetween fixed and such a manner that said sensor and said object have said relative, positional relationship therebetween varied.

5. The information generating apparatus according to claim 1, wherein said determination unit determines which one of said fixed-image comparison unit and said varying-image comparison unit should be employed to compare said image data input, as based on how said relative, positional relationship between said sensor and said object varies as time elapses when said image input unit inputs image data of said object.

6. The information generating apparatus according to claim 5, wherein;
said image input unit inputs more than one item of said image data as said time elapses; and
said determination unit detects, as based on said plurality of image data input by said image input unit, how said relative, positional relationship between said sensor and said object varies as said time elapses when said image input unit inputs image data of said object.

7. The information generating apparatus according to claim 1, wherein said select unit activates one of said fixed-image comparison unit and said varying-image comparison unit in accordance with said decision data.

8. The information generating apparatus according to claim 1, wherein said determination unit starts decision-making when a predetermined period of time elapses after said image input unit starts to input said image data.

9. The information generating apparatus according to claim 1, wherein when said image data input indicates said relative, positional relationship varying in an amount larger than a predetermined amount said determination unit determines that said varying-image comparison unit is employed for comparison, otherwise said determination unit determines that said fixed-image comparison unit is employed for comparison.

10. The information generating apparatus according to claim 1, wherein:
if said determination unit detects that said image input unit still inputs image data and that said relative, positional relationship varies in an amount larger than a predetermined amount then said determination unit determines that image data input by said image input unit is compared by said varying-image comparison unit; and
if said determination unit detects that said image input unit completes inputting image data and that said relative, positional relationship varies in an amount of at most said predetermined amount then said determination unit determines that said fixed-image comparison unit is employed for comparison.

11. The information generating apparatus according to claim 1, wherein:
said object is a fingerprint; and
said comparison result data includes data indicating to which one of right and left hands said fingerprint belongs.

12. The information generating apparatus according to claim 1, wherein:
said object is a fingerprint; and
said comparison result data includes data indicating to which one of a thumb, an index finger, a middle finger, a ring finger and a little finger said fingerprint belongs.

13. The information generating apparatus according to claim 1, wherein said comparison result data output by said varying-image comparison unit includes data indicating in which direction said object positionally moves relative to said sensor, as indicated by said relative, position relationship as it varies.

14. The information generating apparatus according to claim 1, wherein said information generating unit generates information for editing a document.

15. A method of generating information, comprising the steps of:
inputting an image, inputting image data of an object via a previously prepared sensor;
comparing a fixed image, comparing said image data input in the step of inputting in such a manner that said sensor and said object read by said sensor to provide an image have a fixed, relative, positional relationship therebetween with reference image data read from a previously prepared reference image storage unit, and outputting a result of comparing said image data;
comparing a varying image, comparing said image data input in the step of inputting in such a manner that said relative, positional relationship varies with said reference image data read from said reference image storage unit, and outputting a result of comparing said image data;
making a decision from said image data input as to which one of the step of comparing a fixed image and the step of comparing a varying image should be employed to compare said image data input with said reference image data, and outputting a result of said decision;
selecting one of the step of comparing a fixed image and the step of comparing a varying image in accordance with said result of said decision output in the step of making a decision; and
generating information as based on said result of said decision output in the step of making a decision, and said result of comparing said image, as output from one of the step of comparing a fixed image and the step of comparing a varying image, as selected in the step of selecting.

16. An information generating program product for causing a computer to perform the method of generating information as recited in claim 15.

17. A machine readable storage medium having an information generating program stored therein for causing a computer to perform the method of generating information as recited in claim 15.
